(19) United States
(12) Patent Application Publication
(10) Pub. No.: US 2025/0330855 A1
(43) Pub. Date: Oct. 23, 2025

(54) LAYER 1 REPORT ENHANCEMENT FOR BASE STATION AIDED BEAM PAIR PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US); Taesang YOO, San Diego, CA (US); Tianyang BAI, Mountain View, CA (US); Arumugam CHENDAMARAI KANNAN, San Diego, CA (US)

(21) Appl. No.: 18/860,607

(22) PCT Filed: Jul. 7, 2022
(86) PCT No.: PCT/CN2022/104355

§ 371 Date: Oct. 25, 2024

(51) Int. Cl. H04W 24/10; H04B 7/06; H04B 17/318

(52) U.S. Cl. CPC H04W 24/10; H04B 7/0626; H04B 7/06952; H04B 17/328

(57) ABSTRACT

An apparatus for wireless communication at a UE is disclosed. The apparatus comprises memory and at least one processor coupled to the memory. The apparatus is configured to measure a CMR for each of one or more downlink transmission beams. The apparatus is further configured to transmit a L1 measurement report including one or more measurements for the CMR and a reception beam identifier (ID) for a reception beam for each of the one or more measurements. Different measurements associated with a same CMR are associated with different UE identified reception beams

### TECHNICAL FIELD

The present disclosure relates generally to communication systems, and more particularly, to wireless communication that includes layer 1 (L1) reports.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus measures a channel measurement resource (CMR) for each of one or more downlink transmission beams. The apparatus transmits a layer 1 (L1) measurement report including one or more measurements for the CMR and a reception beam identifier (ID) for a reception beam for each of the one or more measurements, wherein different measurements associated with a same CMR are associated with different UE identified reception beams.

In an aspect of the disclosure, a method, a computer-readable medium, and an apparatus are provided for wireless communication at a network node. The apparatus obtains a layer 1 (L1) measurement report including one or more measurements for a channel measurement resource (CMR) and a reception beam identifier (ID) for a reception beam for each of the one or more measurements at a user equipment (UE), wherein different measurements associated with a same CMR are associated with different UE identified reception beams. The apparatus activates at least one transmission configuration indication (TCI) state having a quasi co-location (QCL) relationship to the receive beam at the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 depicts an example artificial intelligence (AI)/machine learning (ML) algorithm.

FIG. 5 is a diagram illustrating example communications between a base station and a UE for beamforming, in accordance with various aspects of the present disclosure.

FIG. 6 is a diagram that illustrates example AI/ML based beam prediction.

FIG. 7 is a diagram that depicts example beam pair prediction.

FIG. 8 is a diagram that depicts an example enhanced L1 report that is based upon beam pairs.

FIG. 9 is a diagram that depicts associations between UE Rx beam identifiers and UE Rx beams.

FIG. 10 is a diagram that depicts an example of compression of an enhanced L1 report.

FIG. 11 is a diagram that depicts another example of compression of an enhanced L1 report.

FIG. 12 is a diagram that depicts yet another example of compression of an enhanced L1 report.

FIG. 13 is a diagram that depicts different schemes for reporting compressed payloads.

FIG. 14 is a diagram that depicts an example of CSI report partitioning.

FIG. 15 is a diagram that depicts another example of CSI report partitioning.

FIG. 16 is a diagram that depicts an example of generating multiple CSI reports.

FIG. 17 is a diagram that depicts example TCI state activation/switching for beam pairs.

FIG. 18 illustrates an example communication flow between a UE and a base station.

FIG. 19 is a diagram illustrating an example of a TCI state, in accordance with the present disclosure.

FIG. 20 is a diagram illustrating examples of TCI state switching timelines, in accordance with the present disclosure.

FIG. 21 is a diagram illustrating an example of predicting channel characteristics, in accordance with the present disclosure.

FIG. 22 is a diagram illustrating an example of using a semi-known TCI state, in accordance with the present disclosure.

FIG. 23 is a flowchart of a method of wireless communication.

FIG. 24 is a flowchart of another method of wireless communication.

FIG. 25 is a diagram illustrating an example of a hardware implementation for an example apparatus and/or network entity.

FIG. 26 is a diagram illustrating an example of a hardware implementation for an example network entity.

### DETAILED DESCRIPTION

Beam management refers to techniques and processes used to achieve transmission and reception of data over relatively narrow beams. Predictive beam management can result in reduced power consumption and overhead reduction while improving accuracy, latency, and throughput. A UE may be configured to report beam qualities in the form of a report that is provided to the base station. However, the report transmitted to the base station by the UE may be based on a transmission (Tx) beam from the base station. Aspects presented herein enable a base station to perform beam management by selecting a reception beam at a UE based on an L1 report that includes reception beam information associated with the L1 measurements. In some aspects, the L1 report may be for base station aided beam pair predictions. As an example, a UE may measure a channel measurement resource (CMR) for each of one or more downlink transmission beams. The UE may transmit a layer 1 (L1) measurement report including one or more measurements for the CMR and a reception beam identifier (ID) for a reception beam for each of the one or more measurements, wherein different measurements associated with a same CMR are associated with different UE identified reception beams. Through utilizing such L1 reports for ML model training purposes and at inference, the L1 report can reduce a number of beams swept during beam sweeping and aid in base station aided beam pair prediction. As such, the enhanced L1 report can reduce latency and UE power consumption. Additionally, other aspects described herein include report compression, CSI partitioning, and TCI state activation/switching based upon the enhanced L1 report.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals include a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB (e.g. which may be referred to as a gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

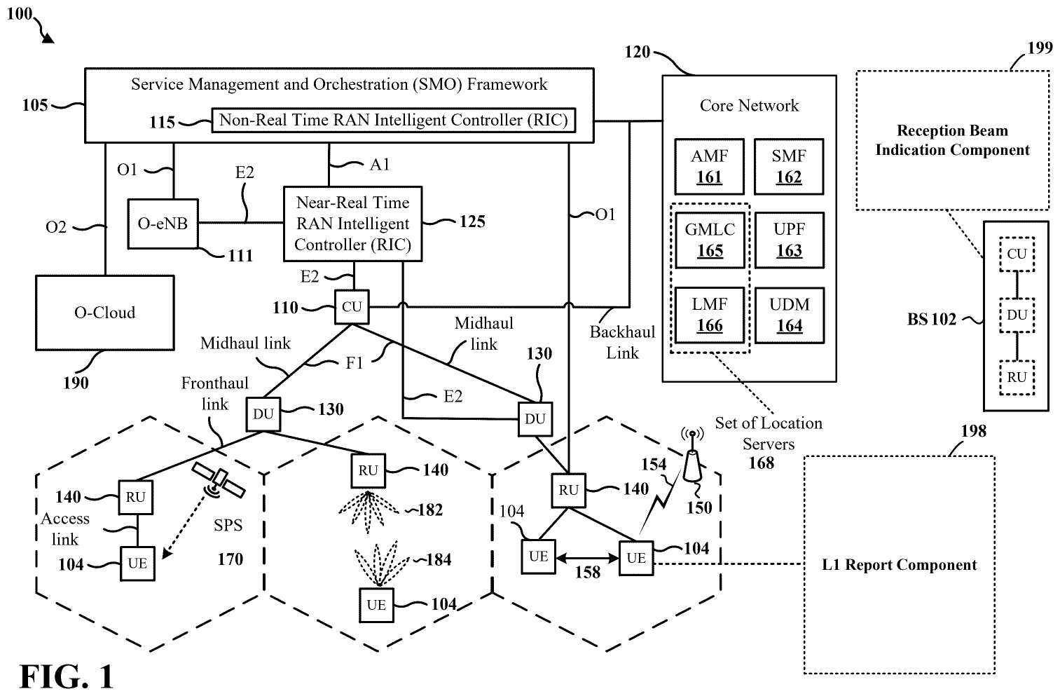

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an L1 report component 198 configured to measure a CMR for each of one or more downlink transmission beams and to transmit a L1 measurement report including one or more measurements for the CMR and a reception beam ID for a reception beam for each of the one or more measurements, where different measurements associated with a same CMR are associated with different UE identified reception beams. In some aspects, the base station 102 may include a reception beam indication component 199 configured to obtain an L1 measurement report including one or more measurements for a CMR and identify a reception beam at a UE for each of the one or more measurements and activate at least one TCI state having a QCL relationship to the receive beam at the UE. Although the following description may be focused on 5G NR, the concepts described herein may be applicable to other similar areas, such as LTE, LTE-A, CDMA, GSM, and other wireless technologies.

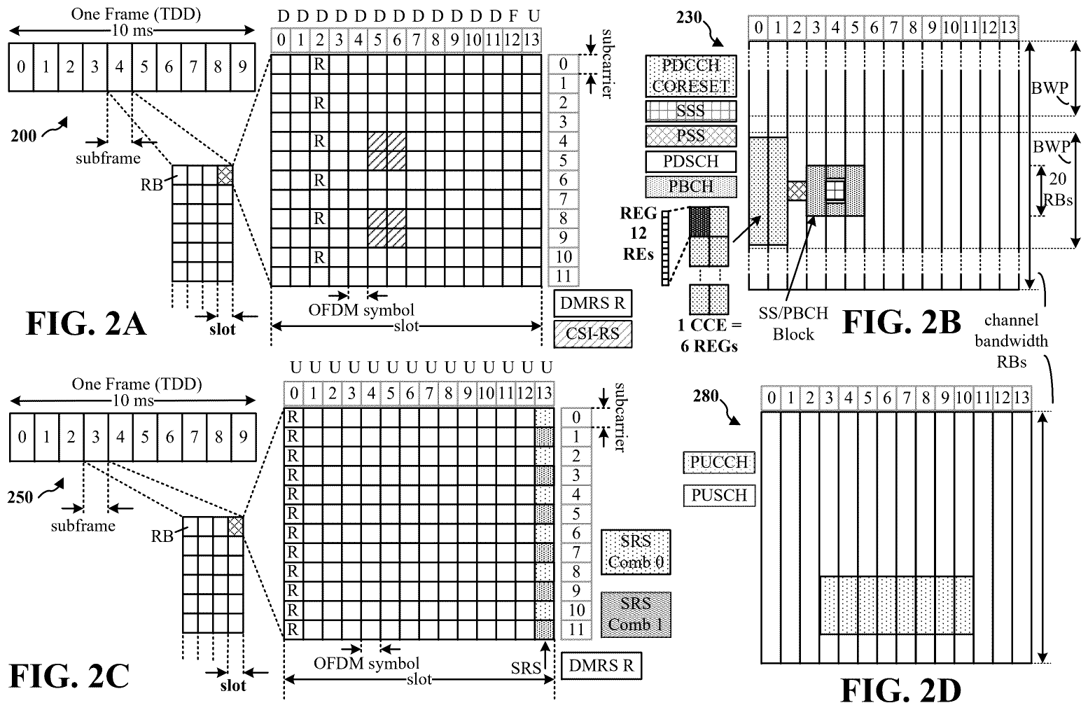

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

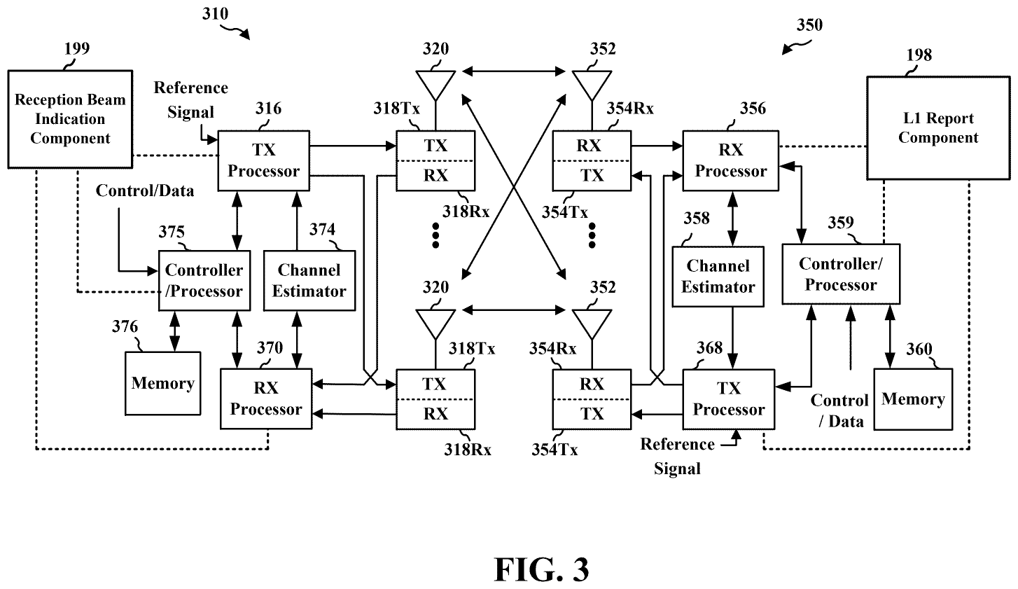

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the L1 report component 198 of FIG. 1.

At least one of the TX processor 316, the RX processor 370, and the controller/processor 375 may be configured to perform aspects in connection with the reception beam indication component 199 of FIG. 1.

Beam management refers to techniques and processes used to achieve transmission and reception of data over relatively narrow beams. Beam management provides a means for both a base station antenna and a UE antenna to lock on to a beam that provides a path from a transmitter to a receiver. Beam management may involve beamforming, beam sweeping, beam measurement, beam determination, and beam reporting. Beam sweeping refers to a base station antenna transmitting beams in a predetermined sequence for beam measurement at the UE. Beam measurement refers to the UE measuring qualities of received beamformed signals. Beamform determination refers to a UE selecting a beam based upon the measured qualities. Beam reporting refers to the UE reporting information to the base station based upon the qualities.

As noted above, during beam measurement, a UE identifies qualities of the beams via measurements at the UE. The UE utilizes power and/or computational overhead in order to perform the measurements. Such power and/or computational overhead may negatively affect accuracy of the measurements. Furthermore, latency and/or throughput may be impacted by beam selection/reselection/recovery.

Predictive beam management in the time domain (TD), frequency domain (FD), and/or spatial domain (SD) can result in reduced power consumption and overhead reduction while improving accuracy, latency, and throughout. For instance, by predicting non-measured beam qualities, power consumption and/or overhead at the UE can be reduced while increasing accuracy. Furthermore, by predicting future beam blockage and/or failures, latency and/or throughput can be improved. However, predicting future transmission beam qualities may depend on movement speed and/or a trajectory of a UE, and predicting future received beams may not properly account for interference. As such, predicting future beams is challenging using statistical signaling processing methods.

Predictive beam management may involve the use of AI/ML models in order to address issues relating to overhead, complexity, and latency. For instance, a ML model may be trained to predict beam qualities, candidate beams, beam failure, and/or beam blockage. In an example, a beam quality may be a layer 1 reference signal received power (L1-RSRP) measurement or a layer 1 signal to interface noise ratio (L1-SINR) measurement. Predicting beam qualities and/or candidate beams may result in reduced UE power consumption and/or reduced UE overhead with respect to radio signaling. Predicting beam failures and/or blockages can result in improved latency and/or throughput.

Predictions via AI/ML models may be performed at a base station or at a UE. In general, the base station may have more computational resources that can be utilized for prediction in comparison to computational resources available to the UE. However, the UE may have access to more observations (e.g., measurements) than the base station. As such, the UE may generate predictions that are more accurate than predictions generated by the base station. However, predictions performed by the UE consume power, which may be limited at the UE. AI/ML models may be trained at the base station (or at some other computing device that is remote from the UE). When an AI/ML model is trained at the base station, training data can be collected via an enhanced air interface or via an application layer approach. When the AI/ML model is trained at the UE, additional UE computation, buffering, and data storage may be used for model training.

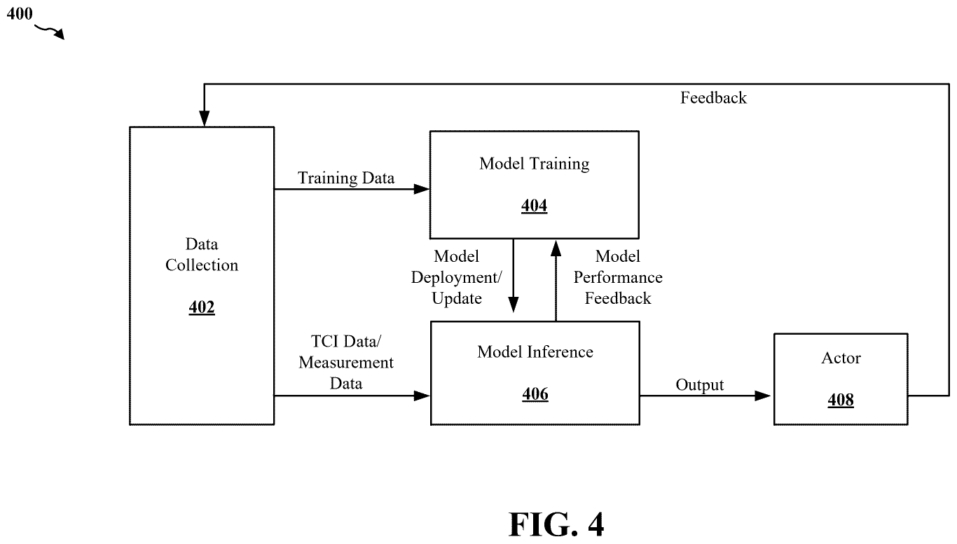

FIG. 4 an example of the AI/ML algorithm 400 that may be used in connection with wireless communication. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation). The examples of input data may include, but not limited to, channel state information (CSI) measurements, such as L1-RSRPs or L1-SINRs, from UEs or network nodes, feedback from the actor 408, output from another AI/ML model. The data collection 402 may include training data, which refers to the data to be sent as the input for the AI/ML model training function 404, and inference data, which refers to be sent as the input for the AI/ML model inference function 406.

The model training function 404 may be a function that performs the ML model training, validation, and testing, which may generate model performance metrics as part of the model testing procedure. The model training function 404 may also be responsible for data preparation (e.g. data pre-processing and cleaning, formatting, and transformation) based on the training data delivered or received from the data collection 402 function. The model training function 404 may deploy or update a trained, validated, and tested AI/ML model to the model inference function 406, and receive a model performance feedback from the model inference function 406.

The model inference function 406 may be a function that provides the AI/ML model inference output (e.g. predictions or decisions). The model inference function 406 may also perform data preparation (e.g. data pre-processing and cleaning, formatting, and transformation) based on the inference data delivered from the data collection 402 function. The output of the model inference function 406 may include the inference output of the AI/ML model produced by the model inference function 406. The details of the inference output may be use-case specific. As an example, the output may include a predicted L1-RSRP, a predicted L1-SINR, a predicted candidate beam, a predicted beam failure, or a predicted beam blockage. In some aspects, the actor may be a UE or a base station.

The model performance feedback may refer to information derived from the model inference function 406 that may be suitable for improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide a feedback information that the model training function 404 or the model interference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including the identification of neighbor TCI candidates for autonomous TCI candidate set updates based on DCI selection of a TCI state.

In some aspects described herein, the network may train one or more neural networks to learn dependence of measured qualities on individual parameters. Among others, examples of machine learning models or neural networks that may be comprised in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

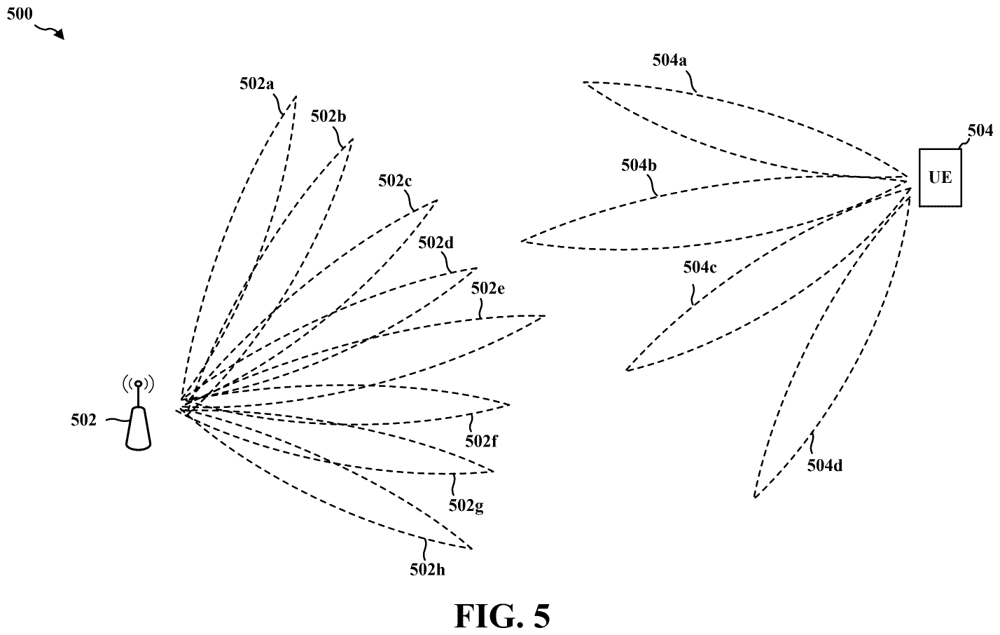

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times. As described in connection with example 500 in FIG. 5, the base station 502 and UE 504 may communicate over active data/control beams both for DL communication and UL communication. The base station and/or UE may switch to a new beam direction using beam failure recovery procedures. Referring to FIG. 5, the base station 502 may transmit a beamformed signal to the UE 504 in one or more of the directions 502a, 502b, 502c, 502d, 502e, 502f, 502g, 502h. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training to determine the best receive and transmit directions for each of the base station 502/UE 504. The transmit and receive directions for the base station 502 may or may not be the same. The transmit and receive directions for the UE 504 may or may not be the same.

In response to different conditions, the UE 504 may determine to switch beams, e.g., between beams 502a-502h. The beam at the UE 504 may be used for reception of downlink communication and/or transmission of uplink communication. In some examples, the base station 502 may send a transmission that triggers a beam switch by the UE 504. For example, the base station 502 may indicate a transmission configuration indication (TCI) state change, and in response, the UE 504 may switch to a new beam for the new TCI state of the base station 502. In some instances, a UE may receive a signal, from a base station, configured to trigger a transmission configuration indication (TCI) state change via, for example, a MAC control element (CE) command. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. In some aspects, a single MAC-CE command may be sent by the base station to trigger the changing of the TCI state on multiple CCs.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam).

A UE may monitor the quality of the beams that it uses for communication with a base station. For example, a UE may monitor a quality of a signal received via reception beam(s). A beam failure detection (BFD) procedure may be used to identify problems in beam quality and a beam recovery procedure (BFR) may be used when a beam failure is detected. The measurements may include deriving a metric similar to a signal to noise and interference ratio (SINR) for the signal, or RSRP strength or block error rate (BLER) of a reference control channel chosen by base station and/or implicitly derived by UE based on the existing RRC configuration. The UE may measure a RS such as a CSI-RS, a synchronization signal block (SSB), or other RS for time and/or frequency tracking, or the like. The UE may receive an indication of reference signal resources to be used to measure beam quality. The measurement(s) may indicate the UE's ability to decode a transmission, e.g., a DL control transmission from the base station.

As presented herein, a UE may be configured to report beam qualities in the form of a report that is provided to the base station. As an example, the UE may transmit an L1-RSRP report to the network based on measurements of SSBs received from a base station. As an example, the UE may report a strongest SSBRI using a first number of bits and may report measurement information for one or more other SSBRIs using a reduced number of bits. As one example, the UE may report the strongest SSBRI using 7 bits to report an RSRP in a range of [−140,−44] dBm with a 1 dBm step size. For the other SSBRIs, the UE may use a reduced number of bits such 4 bits to report a differential RSRP with respect to the L1-RSRP measured for the strongest SSBRI as a reference. For example, the UE may report the other SSBRIs with 4 bits to report a differential RSRP in a range of [0,−30] dB with a 2 dB step size and a reference to the strongest SSBRI's L1-RSRP. A mapping may be defined, known, or provided between the code points of the larger bit indication for the strongest SSBRI, the reduced bit indication for the differential measurement of the other SSBRIs and the actual RSRP value.

As noted above, the base station may engage in predictive beam management due to the relatively greater amount of computational resources and memory available to the base station in comparison to the UE. The base station may assist the UE with predicting qualities of other beam pairs. However, a report transmitted to the base station by the UE may not have information pertaining to which received (Rx) beams the UE has measured regarding a particular transmission (Tx) beam. For instance, the UE may measure L1-RSRPs regarding a particular Tx beam using different Tx beams over multiple P/SP-SMR TD occasions and report a filtered L1-RSRP associated with different received (Rx) beams for the Tx beam. Such an approach may generally require a longer duration or UE filtering efforts to determine a proper L1-RSRP for a particular Tx beam. The base station may find it challenging to predict preferred beam pairs for the UE. For instance, a ML model trained upon data that does not include which Rx beams the UE measured for a Tx beam may not accurately predict a preferred beam pair that includes a transmission beam from the base station and a reception beam at the UE. According to an aspect, a UE may report preliminary information regarding the UE's Rx beam information, such as shapes, beam width, and/or directions. The preliminary information may be indexed within UE reported Rx beams. The base station may inform the UE of the beams to be measured and/or predicted.

To address these issues, an L1 report for base station aided beam pair prediction is described herein, which reports measurement information with corresponding reception beam information. In some aspects, the L1 report may be referred to as an “enhanced L1 report.” The L1 report includes identifiers for Rx beams that the UE measured for a measurement associated with a given Tx beam. The reported Rx beam information in the L1 report can be based on indexing the UE reported Rx beams. A ML model, such as described in connection with FIGS. 4 and/or 6, may be trained based upon the L1 reports. At inference, the ML model may output a preferred beam pair of a transmission beam and reception beam based upon the L1 report, where the prediction may be more accurate than a prediction output by a ML model trained without the L1 reports. Through utilizing L1 reports for ML model training purposes and at inference, such L1 reports can reduce a number of beams swept during beam sweeping and aid in base station aided beam pair prediction. As such, the L1 report and reception beam selection by the base station can reduce latency and UE power consumption. Additionally, other aspects described herein may include report compression, CSI partitioning, and TCI state activation/switching based upon the L1 report.

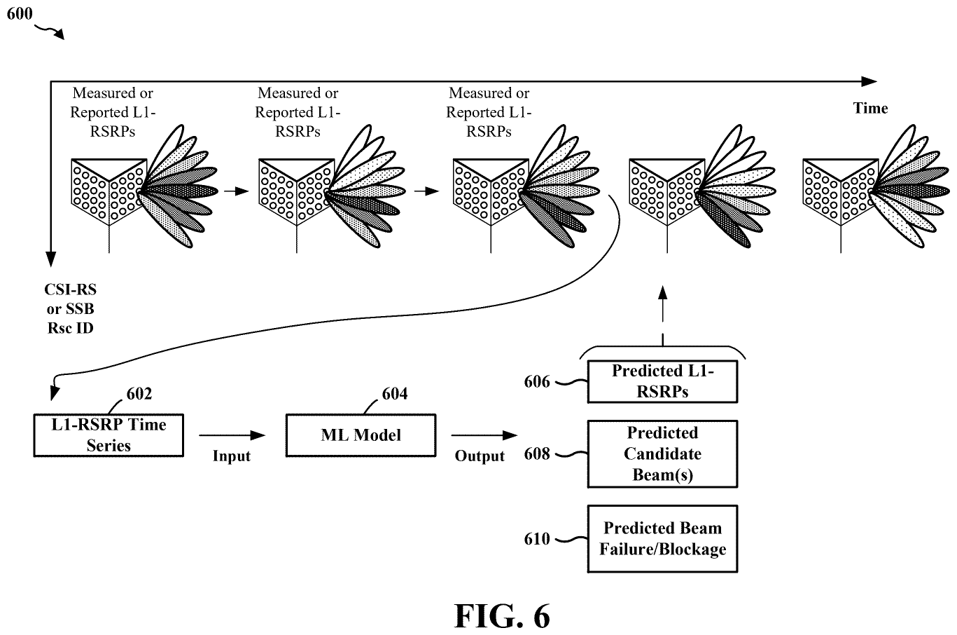

FIG. 6 is a diagram 600 that illustrates example AI/ML based beam prediction. As illustrated in the diagram 600, L1-RSRP time series measurements 602 are generated by a UE (e.g., the UE 104, the UE 350, the UE 504) for one or more channel resource indicator reference signals (CSI-RS) or a synchronization signal block (SSB). The L1-RSRP time series measurements 602 are provided as input to a ML model 604. The ML model 604 may be or include a model described above in the description of FIG. 4. When the ML model 604 is located at a base station (e.g., the base station 102, the base station 310, the base station 502), the L1-RSRP time series measurements 602 are reported by the UE to the base station. When the ML model 604 is located at the UE, the L1-RSRP time series measurements 602 are measured by the UE.

The ML model 604 may be trained to perform different types of predictions. In one example, the ML model 604 is trained to predict future L1-RSRPs 606 based upon the L1-RSRP time series measurements 602. In another example, the ML model 604 is trained to predict one or more candidate beams 608 based upon the L1-RSRP time series measurements 602. In yet another example, the ML model 604 is trained to predict beam failures and/or blockage 610. Predicting the future L1-RSRPs 606 and/or the one or more candidate beams 608 may result in reduced power consumption by the UE and/or may reduce UE reference signal overhead. Predicting beam failure and/or blockage may improve latency and/or throughput. Although FIG. 6 depicts the use of L1-RSRP measurements, it is to be understood that other measurements, such as L1-SINR measurements, may be used in addition or in place of the L1-RSRP measurements.

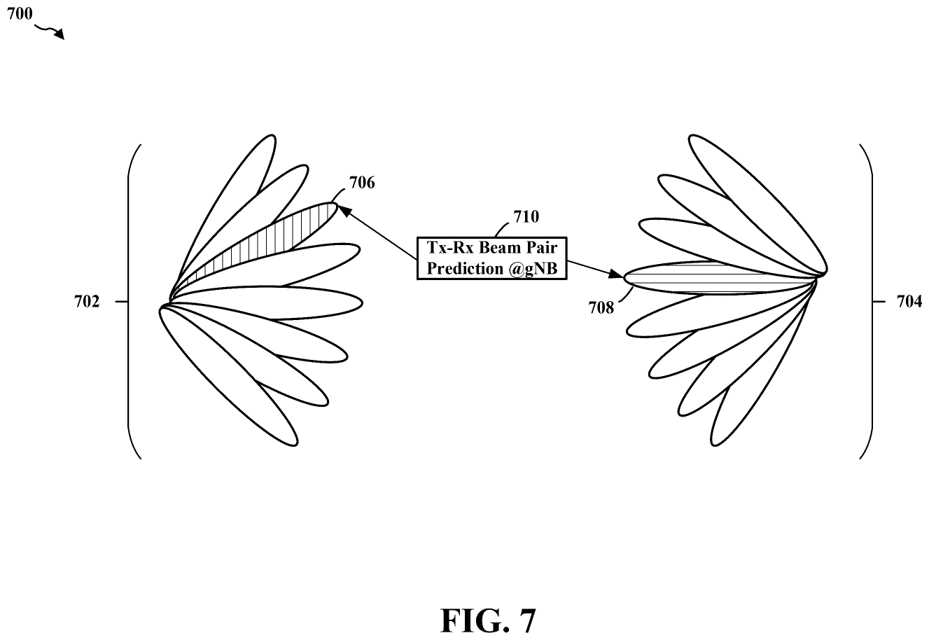

FIG. 7 is a diagram 700 that depicts an example beam pair prediction, e.g., 710, performed by a base station. As illustrated in the diagram, the base station emits Tx beams 702 and the UE receives Rx beams 704. Based upon the L1 report described herein that includes reception beam information for L1 measurement reporting, the base station may predict that a Tx beam 706 from the Tx beams 702 and a Rx beam 708 in the Rx beams 704 will provide improved communication with the UE.

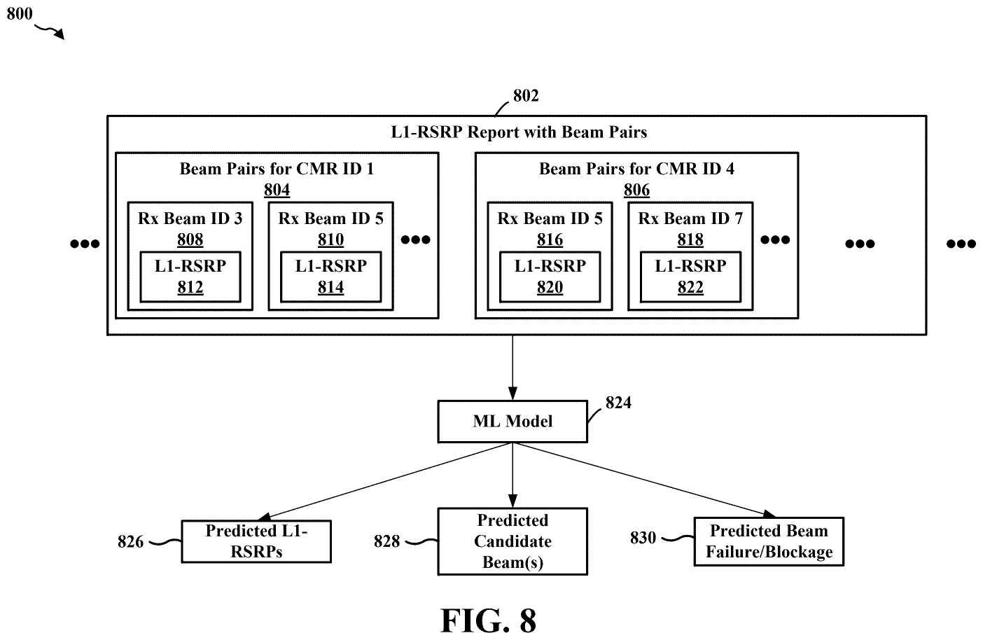

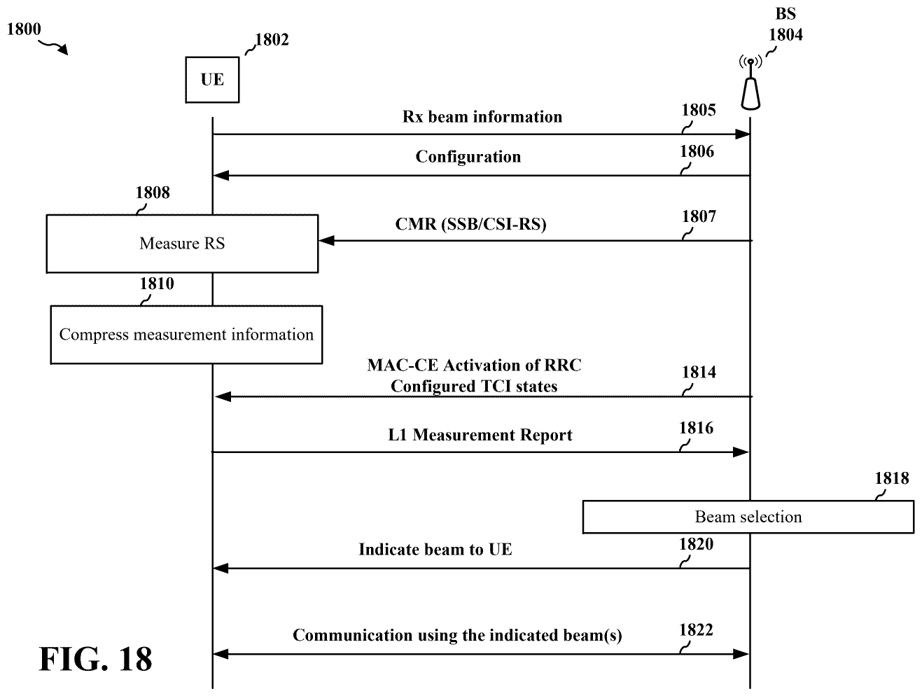

FIG. 8 is a diagram 800 that depicts an example L1 report 802 that is based upon beam pairs and that include reception beam information for corresponding measurements. The UE may be configured to generate the L1 report 802 by at least one CSI report setting. FIG. 18 illustrates an example communication flow 1800 between a UE 1802 and a base station 1804. As illustrated at 1806, the UE 1802 may receive a configuration from the base station 1804, and the configuration may include a settings for L1 measurements and/or L1 measurement reporting for the UE. As an example, a report quantity of the at least one CSI report setting in the configuration at 1806 may include one or more L1-RSRP(s) and/or L1-SINR(s) associated with a particular number of downlink channel management resources (CMRs) with a CMR set associated with the CSI report setting and a CMR ID. The report quantity of the at least one CSI report setting further includes Rx beam IDs that determined each of the L1-RSRP(s) and/or L1-SINR(s) for each CMR. CMRs may include a CSI-RS resource and/or a SSB resource. For example, a CMR ID may correspond to an SSB ID or a CSI-RS ID. The SSB ID or CSI-RS ID may indicate a transmission beam of the SSB or CSI-RS from the base station, for example. The L1 report 802 indicates beam pairs for different CMRs, e.g., by including information indicating an Rx beam ID for the corresponding CMR ID (which indicates the Tx beam of the beam pair associated with the measurement). If different Rx beams are associated with a same CMR in a single reporting occasion (based upon a UE implementation), RSRP/SINR filtering in the TD may occur.

In the example shown in FIG. 8, the L1 report 802 includes an identifier for a first CMR 804 (e.g., CMR ID 1 which may correspond to 502c in FIG. 5, as an example) and an identifier for a fourth CMR 806 (e.g., which may correspond to 502f in FIG. 5, as an example). The first CMR 804 and the fourth CMR 806 respectively may correspond to the transmission of a reference signal, such as a CSI-RS or SSB using different Tx beams emitted by a base station. The identifier for the first CMR 804 may be associated with an identifier for a third Rx beam 808 (e.g., which may correspond to 504a in FIG. 5) and an identifier for a fifth Rx beam 810 (e.g., which may correspond to 504b in FIG. 5) within the L1 report 802. The identifier for the third Rx beam 808 may be associated with a L1-RSRP measurement 812 performed by the UE. The identifier for the fifth Rx beam 810 may be associated with an L1-RSRP measurement 814 performed by the UE. The identifier for the fourth CMR 806 may be associated with an identifier for a fifth Rx beam 816 and an identifier for a seventh Rx beam 818 (e.g., which may correspond to the 504c in FIG. 5). The identifier for the fifth Rx beam 816 may be associated with an L1-RSRP measurement 820 performed by the UE. The identifier for the seventh Rx beam 818 may be associated with an L1-RSRP measurement 822 performed by the UE. For example, in FIG. 18, the UE 1802 may perform measurements (e.g., such as L1-RSRP and/or L1-SINR) on one or more CMRs 1807, at 1808. The UE 1802 may then transmit an L1 measurement report 1816 to the base station 1804, e.g., based on the configuration 1806.

As discussed above, the L1 report 802 can be provided from the UE to the base station and may be used as input to a ML model 824 at the base station. The ML model 824 may then output one or more predictions or beam selections (e.g., Tx-Rx beam pair or Rx beam selection) based upon the L1 report 802. The ML model 824 may include any of the aspects described in connection with the ML model described in connection with FIG. 4 or FIG. 6. In an example, the ML model 824 may be trained to predict L1-RSRPs 826 for a beam pair. In another example, the ML model 824 may be trained to predict candidate beam(s) 828, e.g., including a reception beam at the UE. In yet another example, the ML model 824 may be trained to predict beam failure and/or blockage 830. As shown in FIG. 18, the base station 1804 may select a beam, at 1818, based on the report may indicate to the UE 1802, at 1820, to use a particular reception beam. Then, at 1822, the UE and the base station 1804 may communicate using the indicated reception beam, or a beam pair including a reception beam. For example, at 1822, the UE 1802 may receive downlink communication from the base station 1804 using a reception beam based on the indication received at 1820.

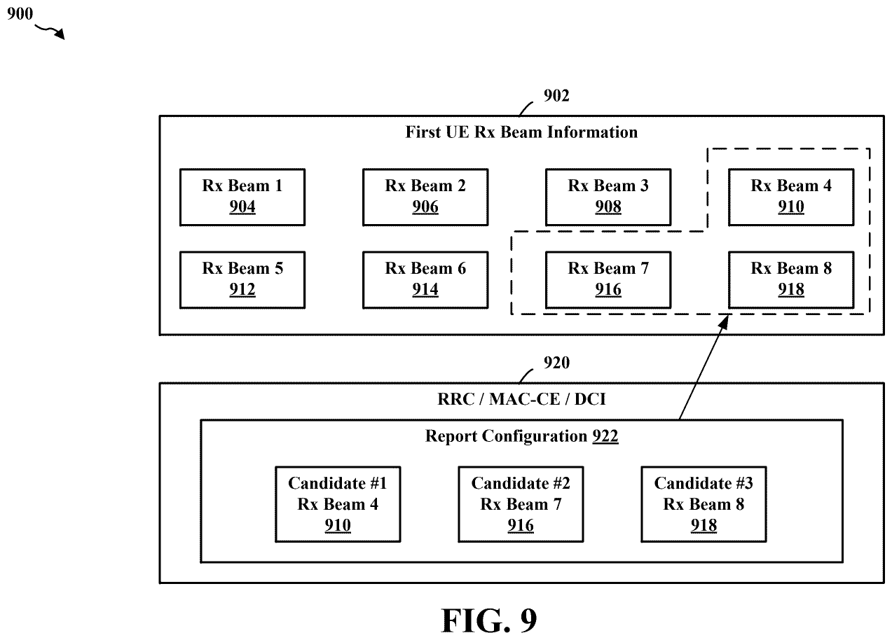

In some aspects, and association may be provided, configured, or known, between an Rx beam ID (e.g., that a UE may indicate in an L1 measurement report) and a corresponding Rx beam at a UE. In some aspects, a UE may first indicate beam information about a set of Rx beams at the UE. For example, in FIG. 18, a UE 1802 may provide Rx beam information 1805 to a base station 1804. FIG. 9 is a diagram 900 that depicts associations between UE Rx beam identifiers and UE Rx beams. The diagram 900 includes first UE Rx beam information 902 for a set of Rx beams at a UE, e.g., which the UE may provide at 1805. The first UE Rx beam information 902 includes information about an example set of eight Rx beams at the UE, e.g., 904, 906, 908, 910, 912, 914, 916, and 918, corresponding to a first number of Rx beams and information associated with each of the first number of Rx beams. The information may include absolute beam pointing direction and/or beam width information. A UE (e.g., the UE 104, the UE 350, the UE 504, the UE 1802) may transmit the first UE Rx beam information 902 to a base station (e.g., the base station 102, the base station 310, the base station 502), at 1805. In some aspects, the UE may report the first UE Rx beam information 902/1805 as UE capability information in RRC signaling.

After receiving the information, the base station may select a particular subset of the set of Rx beam identifiers at the UE, e.g., 904-918 for the UE to report L1 measurements. For example, the base station may select some or all of the Rx beams 904-918. The base station may configure the UE via RRC (CSI report setting), MAC-CE (activating semi-persistent (SP) CSI report), or DCI (triggering aperiodic (AP) CSI report) 920 to provide the L1 measurement report for the indicted set of beams, e.g., as a report configuration 922 indicating a second number of Rx beams indicated by the base station. As an example, in FIG. 18, the configuration 1806 may indicate for the UE 1802 to measure and/or report L1 measurements (such as RSRP or SINR) for a set of candidate Rx beams that are at least a subset of the set of Rx beams for which the UE provided the Rx beam information, at 1805. In the example shown in FIG. 9, the report configuration 922 identifies Rx beam 910, Rx beam 916, and Rx beam 918. The UE may generate an L1 report (e.g., the L1 report 802) for the indicated Rx beams corresponding to the Rx beam 910, Rx beam 916, and Rx beam 918 as described above in FIG. 8. In an example, the beams corresponding to Rx beam 910, Rx beam 916, and Rx beam 918 may be wide beams and beams corresponding to Rx beam 904, Rx beam 906, Rx beam 908, Rx beam 912, and Rx beam 914 may be narrow beams. Through use of the report configuration 922, the base station may assist the UE in predicting information pertaining to the narrow beams. Thus, the UE may skip sweeping beams associated with each of Rx beam 904, Rx beam 906, Rx beam candidate 908, Rx beam candidate 912, and Rx beam candidate 914. In one aspect, a number of bits for reporting a Rx beam identifier in a CSI report may be determined by a number of Rx beams indicated in the report configuration 922. For example, if the report configuration 922 indicates three beams (e.g., candidate beam 1, candidate beam 2, candidate beam 3), the UE may indicate an Rx beam ID in the L1 measurement report according to the set of three candidate beam IDs rather than identifying the corresponding Rx beam from the set of eight beams in 902. In other examples, an association between a set of Rx beam IDs and each of the Rx beams at the UE may be provided, and the UE may indicate the corresponding Rx beam ID in the L1 measurement report for each measurement reported.

In one aspect, a MAC-CE that activates an SP CSI report may indicate the second number of Rx beams, e.g., at 922. In another aspect, a configuration for AP CSI reports may configure the second number of Rx beams, e.g., at 922, and the UE may identify such Rx beams when providing the AP CSI report to the base station. The MAC-CE and/or configuration may correspond to 1806 in FIG. 18, for example.

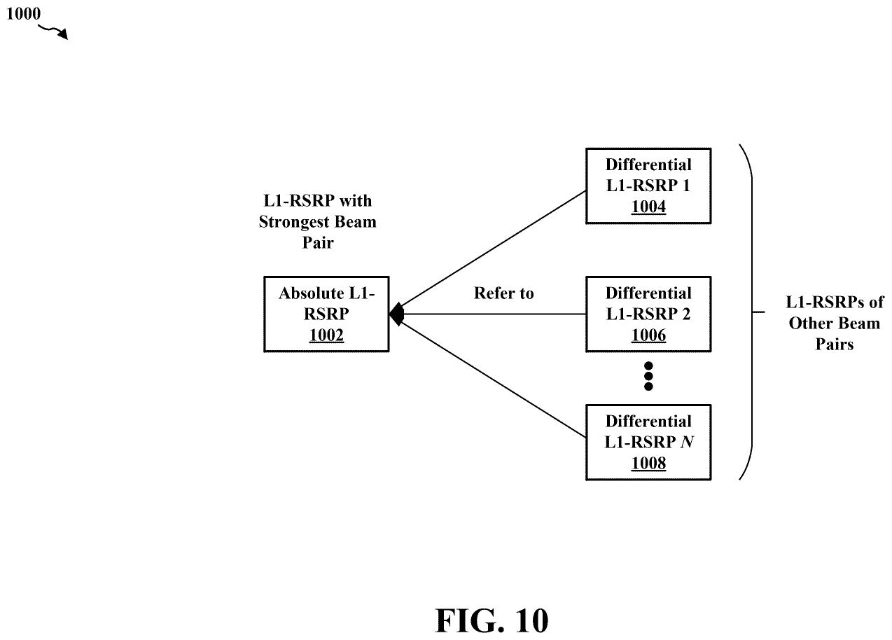

In some aspects, before reporting the L1 measurement report at 1816, the UE 1802 may compress at least a part of the measurement report, at 1810. FIG. 10 is a diagram 1000 that depicts an example of compression of an enhanced L1 report (e.g., the L1 report 802 or 1816) generated by a UE (e.g., the UE 104, the UE 350, the UE 504, the UE 1802). The diagram 1000 shows that the UE may report an absolute L1-RSRP measurement 1002 (e.g., in the L1 report 1816). The absolute L1-RSRP measurement 1002 may be associated with a strongest beam pair within a CSI report (or other L1 measurement report). The diagram 1000 shows that the UE may further report one or more differential L1-RSRP measurements 1004, 1006, 1008 for other beam pairs. Each of the differential L1-RSRP measurements 1004, 1006, 1008 refer to a difference between the absolute L1-RSRP measurement 1002 and a respective (e.g., non-strongest) L1-RSRP measurement. Through the use of differential measurements, a size of the enhanced L1 report may be reduced. Although the diagram 1000 includes L1-RSRP measurements, it is to be understood that L1-SINR measurements may be used in addition or in place of L1-RSRP measurements. Although the example is described for an L1-RSRP measurement, the aspects may be similarly applied for an L1-SINR measurement or other L1 measurement.

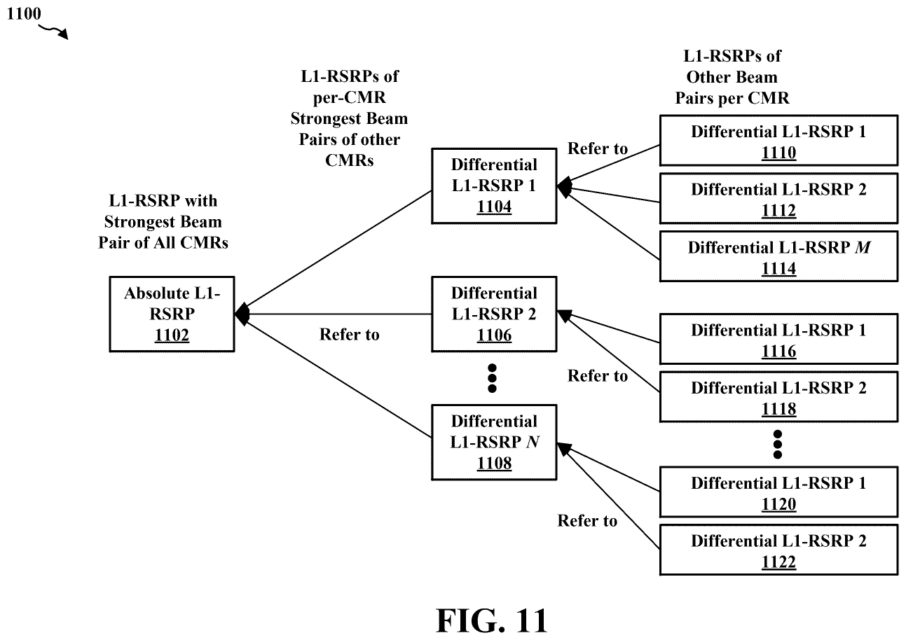

FIG. 11 is a diagram 1100 that depicts another example of compression of an L1 report (e.g., the L1 report 802 and/or 1816) performed by a UE (e.g., the UE 104, the UE 350, the UE 504, the UE 1802). The diagram 1100 shows that the UE may report an absolute L1-RSRP measurement 1102. The absolute L1-RSRP measurement 1102 is associated with the strongest beam pair within the CSI report (from amongst all CMRs). The diagram 1100 shows that the UE may further report first differential L1-RSRP measurements 1104, 1106, 1108, where each of the first differential L1-RSRP measurements 1104, 1106, 1108 refer to a different CMR and where each of the first differential L1-RSRP measurements 1104, 1106, 1108 are associated with a strongest beam pair (i.e., a Tx beam and a Rx beam) for a respective CMR.

The diagram 1100 shows that the UE may further report second differential L1-RSRP measurements 1110, 1112, 1114, third differential L1-RSRP measurements 1116, 1118, and fourth differential L1-RSRP measurements 1120, 1122. Each of the second differential L1-RSRP measurements 1110, 1112, 1114 refer to a difference between the differential L1 RSRP measurement 1104 and an associated L1-RSRP measurement. In an example, the CMR associated with the L1-RSRP measurement 1104 comprises the strongest beam pair, and as such, a number of differential measurements in the second differential L1-RSRP measurements 1110, 1112, 1114 may be greater than a number of measurements for the third differential L1-RSRP measurements 1116, 1118 or the fourth differential L1-RSRP measurements 1120, 1122. Each of the third differential L1-RSRP measurements 1116, 1118 refer to a difference between the differential L1 RSRP measurement 1106 and an associated L1-RSRP measurement. Each of the fourth differential L1-RSRP measurements 1120, 1122 refer to a difference between the differential L1 RSRP measurement 1108 and an associated L1-RSRP measurement. Through the use of differential measurements, a size of the enhanced L1 report may be reduced. Although the diagram 1100 includes L1-RSRP measurements, it is to be understood that L1-SINR measurements may be used in addition or in place of L1-RSRP measurements.

In one aspect, the UE may use different differential quantization tables (e.g., L1-RSRP or L1-SINR tables) for different reporting stages. For instance, the UE may use a first differential quantization table to report the difference between the absolute L1-RSRP measurement 1102 and the first differential L1-RSRP measurements 1104, 1106, 1108 and may use a second differential quantization table to report the difference between the differential L1-RSRP measurement 1104 and the second differential L1-RSRP measurements 1110, 1112, 1114. A differential quantization table may include a number of bits assigned for the reporting of an L1-RSRP/L1-SINR, a step size, and/or a dynamic range.

In one aspect, the UE may be configured to report a downlink CMR identifier and a Rx beam identifier for each beam pair. In an example, the UE may be configured by a CSI report setting to report a dedicated number of beam pairs for a downlink CMR. As such, the UE may report downlink CMR identifiers one time for a set of beam pairs and then reports respective Rx beam identifiers for each downlink CMR ID. In another aspect, the UE may be configured to report different numbers of beam pairs for different downlink CMRs. In an example, the UE may be configured to report four beam pairs for a DL-CMR with a strongest beam pair and the UE may be further configured to report two beam pairs for remaining downlink CMRs.

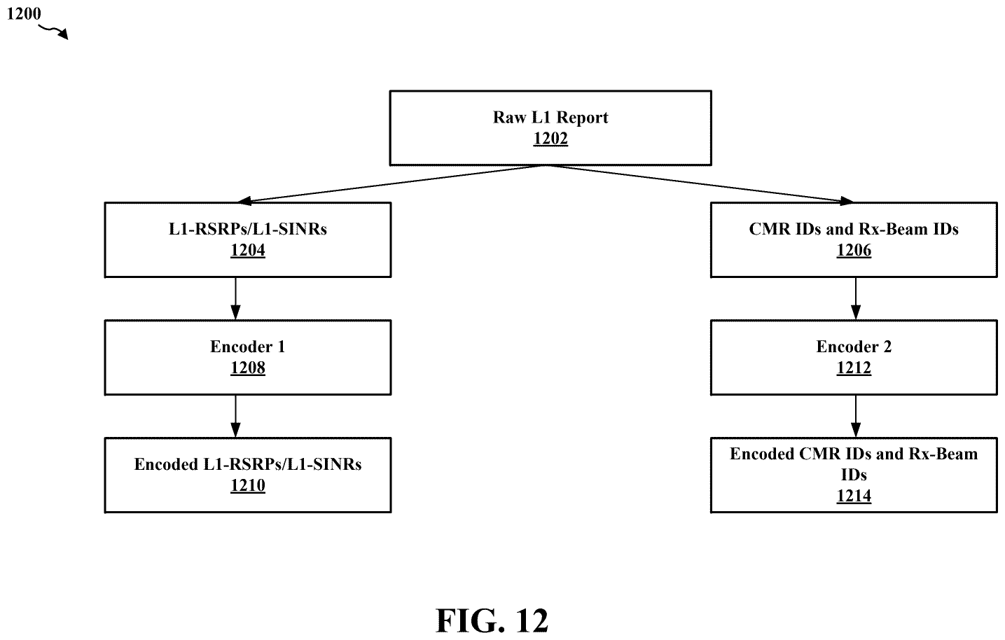

FIG. 12 is a diagram 1200 that depicts yet another example of compression of an L1 report that may be performed by a UE (e.g., the UE 104, the UE 350, the UE 504, the UE 1802). The diagram 1200 includes a raw L1 report 1202 (e.g., the L1 report 802 described above). As described above, the raw L1 report 1202 may include L1-RSRPs and/or L1-SINRs 1204. The raw L1 report 1202 may further include CMR identifiers and Rx-beam identifiers 1206. The UE may provide the L1-RSRPs and/or L1-SINRs 1204 as input to a first encoder 1208. The first encoder 1208 generates encoded L1-RSRPs/L1-SINRs 1210 based upon the L1-RSRPs and/or L1-SINRs 1204, where the encoded L1-RSRPs/L1-SINRs 1210 are a compressed version of the L1-RSRPs and/or L1-SINRs 1204. The UE may also provide the CMR identifiers and Rx-beam identifiers 1206 as input to a second encoder 1212. The second encoder 1212 generates encoded CMR identifiers and Rx-beam identifiers 1214 based upon the CMR identifiers and Rx-beam identifiers 1206, where the encoded CMR identifiers and Rx-beam identifiers 1214 are a compressed version of the CMR identifiers and Rx-beam identifiers 1206. The UE may transmit the encoded L1-RSRPs/L1-SINRs 1210 and the encoded CMR identifiers and Rx-beam identifiers 1214 to a base station (e.g., the base station 102, the base station 310, the base station 502). The base station (e.g., 1804) may decode the encoded L1-RSRPs/L1-SINRs 1210 using a first decoder associated with the first encoder 1208 to obtain the L1-RSRPs and/or L1-SINRs 1204. The base station may also decode the encoded CMR identifiers and Rx-beam identifiers 1214 using a second decoder associated with the second encoder 1212 to obtain the CMR identifiers and Rx-beam identifiers 1206.

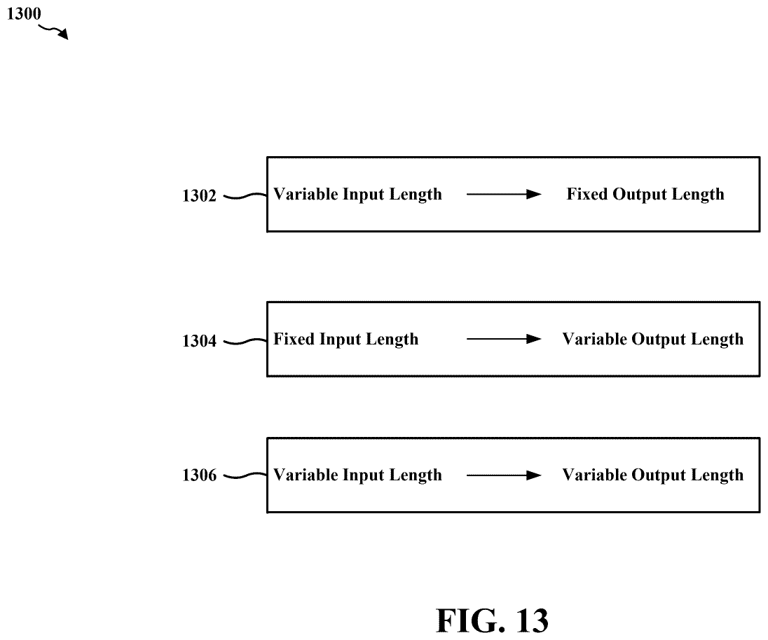

FIG. 13 is a diagram 1300 that depicts different schemes for reporting compressed payloads, e.g., at 1816, (e.g., the encoded L1-RSRPs/L1-SINRs 1210 and the encoded CMR identifiers and Rx-beam identifiers 1214, the differentially reported L1-RSRPs described in FIGS. 10 and 11, etc.). A UE (e.g., the UE 104, the UE 350, the UE 504) first reports a raw payload length (of an uncompressed enhanced L1 report) or a compressed payload length (of a compressed enhanced L1 report) using a fixed bitwidth. The UE may report the payload size of the non-compressed L1 report and/or the payload size of the compressed report explicitly or from multiple preconfigured options in a CSI report setting for P/SP-CSI reports or triggering configurations in the AP-CSI reports. The UE then reports the compressed payloads to a base station (e.g., the base station 102, the base station 310, the base station 502). In one aspect, if a compressed payload size is not reported, the compressed payload is reported via a fixed bitwidth. In another aspect, if the compressed payload size is reported, the compressed payload is reported with a variable bitwidth.

In a first scheme 1302, an input length of the compressed/uncompressed payload is variable and an output length is fixed. In a second scheme 1304, an input length of the compressed/uncompressed payload is fixed and an output length is variable. In a third scheme 1306, an input length of the compressed/uncompressed payload is variable and an output length is variable.

In one aspect, a base station 1804 (e.g., the base station 102, the base station 310, the base station 502) may indicate/configure an associated decoder to the UE 1802, while the encoder is based on a UE implementation. In another aspect, the base station 1804 indicates/configures the encoder(s) (e.g., the first encoder 1208 and the second encoder 1212) to the UE 1802 directly. For example, the base station 1804 may indicate/configure the UE 1802 with such information at 1806.

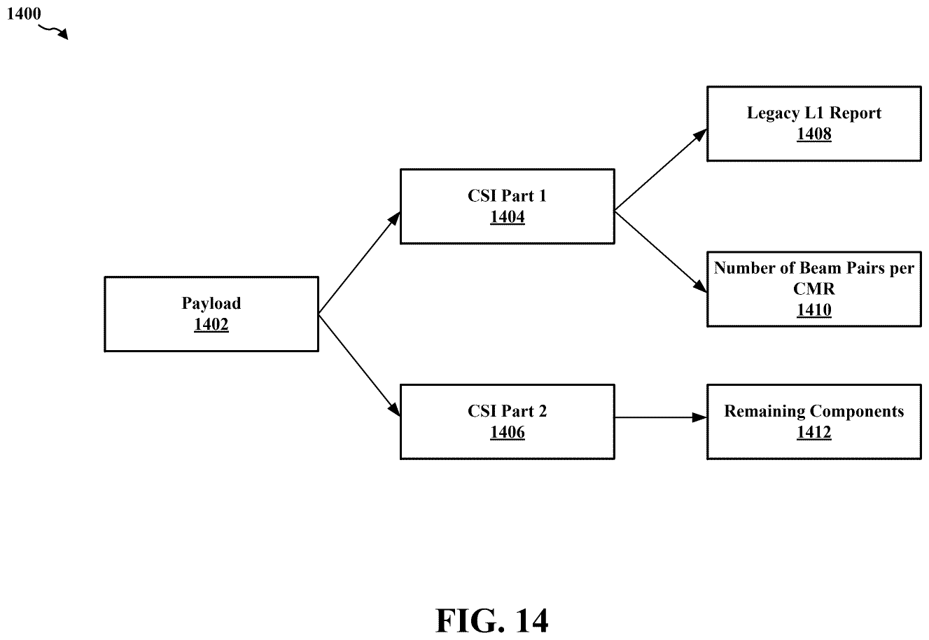

FIG. 14 is a diagram 1400 that depicts an example of CSI report partitioning that may be performed by a UE (e.g., the UE 104, the UE 350, the UE 504, the UE 1802), e.g., when transmitting the L1 measurement report 1816. The diagram 1400 includes a payload 1402 of the measurement report, e.g., 1816. The payload 1402 may be the L1 report 802 described above. The UE 1802 may partition the payload 1402 into a first CSI part 1404 and a second CSI part 1406. The first CSI part 1404 may have a fixed payload size and a relatively higher reliability while the second CSI part 1406 may have a variable payload size and a relatively lower reliability. The first CSI part 1404 may include an L1 report 1408 without reception beam identifiers (e.g., which may be referred to as a legacy L1 report in some aspects) and a number of beam pairs evaluated per CMR 1410. The L1 report 1408 may include a strongest L1-RSRP/L1-SINR measurements for each downlink CMR. The second CSI part 1406 may include remaining components/information 1412 that includes measurements with corresponding reception beam identifiers. The UE 1802 may transmit the first CSI part 1404 and the second CSI part 1406, e.g., as 1816, to a base station 1804 (e.g., the base station 102, the base station 310, the base station 502).

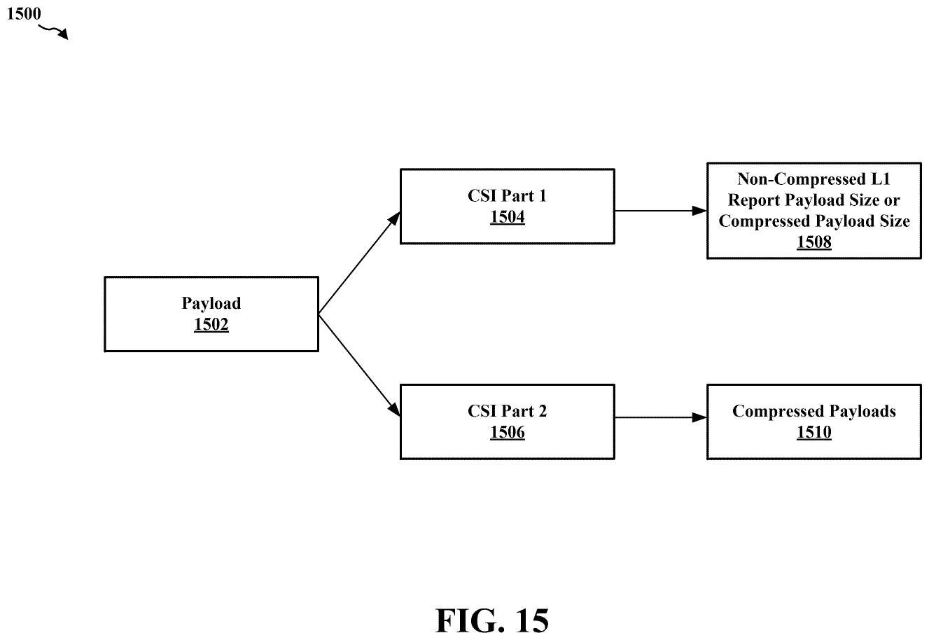

FIG. 15 is a diagram 1500 that depicts another example of CSI report partitioning performed by a UE (e.g., the UE 104, the UE 350, the UE 504). The diagram 1500 includes a payload 1502. The payload 1502 may be the enhanced L1 report 802 and/or a payload that has been compressed according to the descriptions of FIGS. 10, 11, 12, and/or 13 described above. The UE may partition the payload 1502 into a first CSI part 1504 and a second CSI part 1506. The first CSI part 1504 includes a non-compressed L1 report payload size or a compressed payload size 1508. The second CSI part 1506 includes compressed payloads 1510. The compressed payloads may be compressed as described above in the descriptions of FIGS. 10, 11, 12, and/or 13. The UE 1802 may transmit the first CSI part 1504 and the second CSI part 1506, e.g., as the L1 measurement report 1816, to a base station 1804 (e.g., the base station 102, the base station 310, the base station 502).

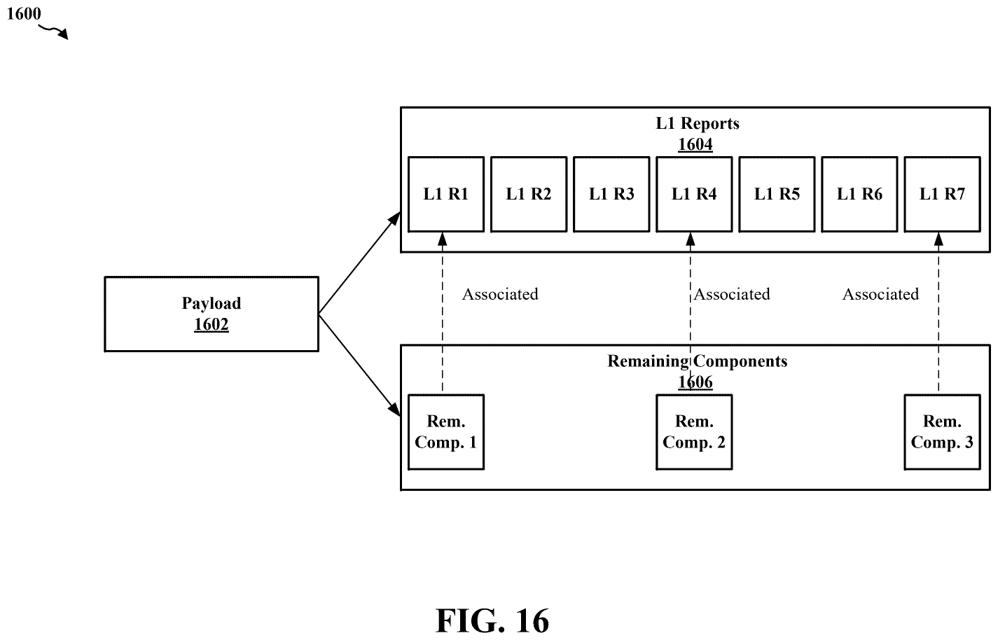

FIG. 16 is a diagram 1600 that depicts an example of generating multiple CSI reports by a UE (e.g., the UE 104, the UE 350, the UE 504, the UE 1802). The diagram 1600 includes a payload 1602. The payload 1602 may be or include an L1 report, the enhanced L1 report 802, and/or a payload that has been compressed according to the descriptions of FIGS. 10, 11, 12, and/or 13 described above. The UE, via multiple CSI report settings, is configured to generate L1 reports 1604 and remaining components 1606. Each L1 report in the L1 reports 1604 may include a strongest L1-RSRP/L1-SINR measurement for each downlink CMR together with an identifier for a respective CMR (which may be referred to as a first CSI report). Each remaining component (which may be referred to as a second CSI report) in the remaining components 1606 comprises an enhanced L1 report (e.g., the enhanced L1 report 802). In one aspect, the UE 1802 reports (e.g., at 1816) the L1 reports 1604 at a first periodicity and the remaining components 1606 at a second periodicity, where the first periodicity is less than the second periodicity. A most recent first CSI report may serve as a reference for a second CSI report.

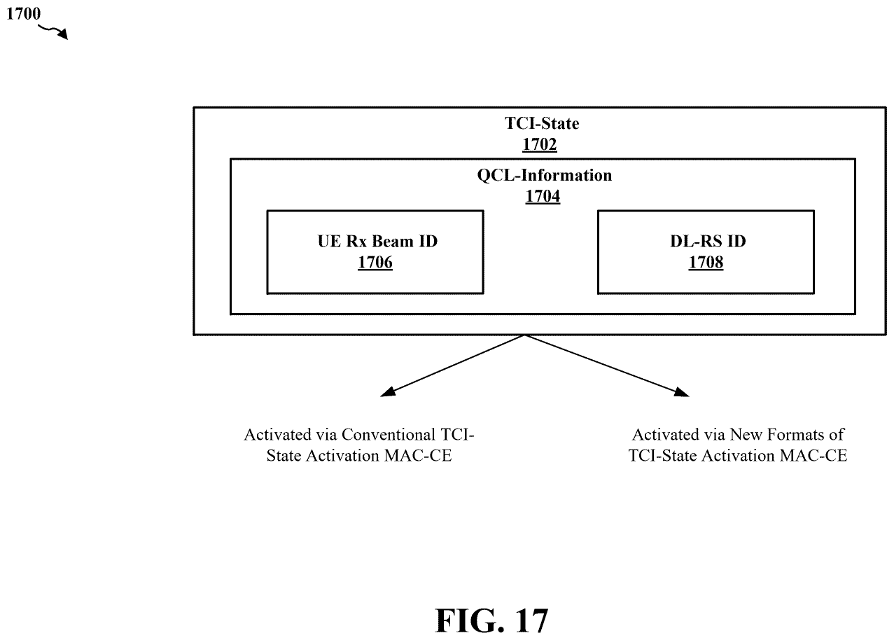

As described in connection with 1818 and 1820, the base station 1804 may use the L1 measurement report 1816 to select a reception beam, or a beam pair including a transmission beam and a reception beam, for the UE 1802 to use to receive downlink communication from the base station 1804. The base station 1804 may indicate the selected Rx beam to the UE, at 1820. As an example, the base station 1804 may indicate a TCI state to the UE 1802, the TCI state including a QCL relationship to an Rx beam at the UE 1802. FIG. 17 is a diagram 1700 that depicts example TCI state activation/switching for beam pairs. The diagram 1700 depicts a TCI state 1702. A UE (e.g., the UE 104, the UE 350, the UE 504) may be configured with a first number of TCI states, where the TCI state 1702 is included in the first number of TCI states, e.g., in an RRC configuration such as the configuration 1806. The TCI state 1702 includes QCL information 1704. The QCL information 1704 includes a UE Rx beam identifier 1706 along with UE Rx beam information (which may be based on the L1 report 802, e.g., 1805, described above). The QCL information 1704 may optionally include a downlink reference signal (DL-RS) identifier 1708. The DL-RS identifier 1708 may be used to determine type A or type C QCL. The TCI state 1702 can be activated via a known TCI-state activation medium access control-control elements (MAC-CE) or by other TCI-state activation MAC-CE.

In one aspect, a second number (e.g., a subset of the first, RRC configured set of TCI states) of TCI states may be activated for the UE 1802 via a MAC-CE 1814. The base station 1804 may then indicate a particular TCI state, at 1820, from the MAC-CE activated TCI states. As an example, at 1820, the base station 1804 may transmit a downlink grant DCI scheduling a PDSCH and indicating a TCI state that includes a QCL relationship to a particular Rx beam at the UE 1802.

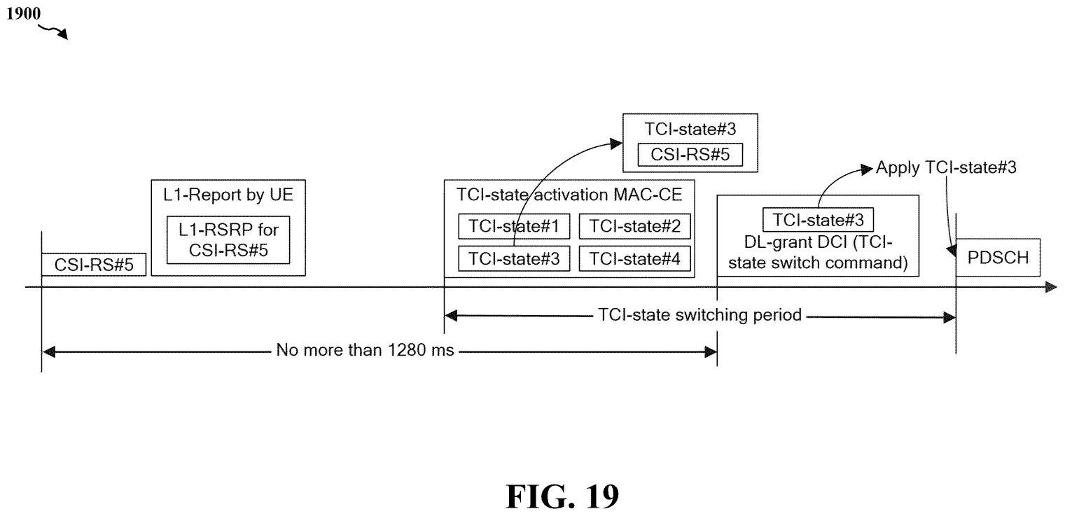

FIG. 19 is a diagram illustrating an example 1900 of a known TCI state, in accordance with the present disclosure.

TCI state switching may involve known TCI states and unknown TCI states. A TCI state switching timeline may specify the delay between receiving a reference signal (RS) resource (e.g., CSI-RS, SSB) used for L1-RSRP measurement reporting for the target TCI state (activated TCI state) and completion of an active TCI state switch. The RS resource is the RS in the activated TCI state or QCLed to the activated TCI state. Example 1900 shows that CSI-RS #5 is the RS and the activated TCI state to be applied to the TCI state switch is TCI-state #3.

The TCI state switching timeline for the TCI state switching period may depend on whether an activated TCI state is known or unknown. A TCI state is known if multiple conditions are met. This may include: (condition #1) if the TCI state switch command is received within a time period (e.g., 1280 milliseconds (ms)) upon the last transmission of the RS resource for beam reporting or measurement; (condition #2) if the UE has transmitted at least 1 L1-RSRP report for the target TCI state before the TCI state switch command; (condition #3) if the TCI state remains detectable during the TCI state switching period (e.g., from the slot carrying the TCI state activation MAC CE to TCI switching completion); and (condition #4) if the SSB associated with the TCI state remains detectable during the TCI switching period. An RS may be detectable by the UE if the signal-to-noise ratio (SNR) for the RS is greater than or equal to 3 decibels (dB). This does not mean that such an RS has been transmitted. This might be verified by the UE via other RSs (e.g., DMRS). If these conditions are not met, the TCI state is unknown.

As indicated above, FIG. 19 is provided as an example. Other examples may differ from what is described with regard to FIG. 19.

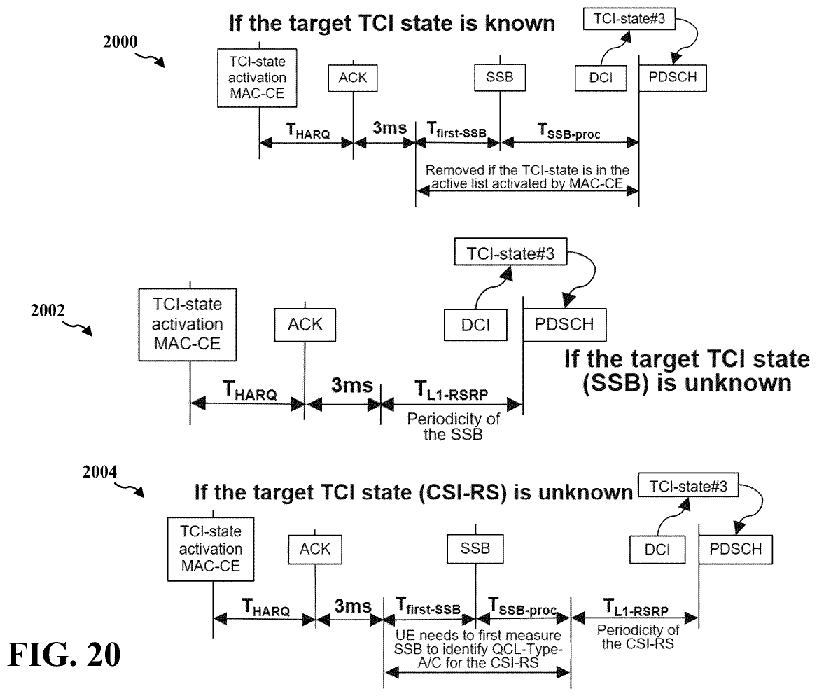

FIG. 20 is a diagram illustrating examples of TCI state switching timelines, in accordance with the present disclosure.

If the target TCI state (activated TCI state) is known (example 2000), upon receiving a PDSCH communication carrying an MAC CE activation command in slot n, the UE may be able to receive the PDCCH communication with the target TCI state of the serving cell on the TCI state switch that occurs at the first slot that is after slot n+T_{HARQ}+(3 ms+TOₖ*(T_{first-SSB}+T_{SSB-proc}))/NR slot length. The UE may be able to receive the PDCCH communication with the old TCI state until slot n+T_{HARQ}+3 ms. T_{first-SSB} may be the time to the first SSB transmission after the MAC CE activation command is decoded by the UE. The SSB may be the QCL-TypeA or QCL-TypeC to the target TCI state. T_{SSB-proc} may be an SSB processing time of 2 ms. TOₖ may be 1 if the target TCI state is not in the active TCI state list for PDSCH, or 0 otherwise.

If the target TCI state is unknown (examples 2002 and 2004), upon receiving the PDSCH communication carrying the MAC CE activation command in slot n, the UE may be able to receive a PDCCH communication with the target TCI state of the serving cell on the TCI state switch that occurs at the first slot that is after slot n+T_{HARQ}+(3 ms+T_{L1-RSRP}+TOᵤₖ*(T_{first-SSB}+T_{SSB-proc}))/NR slot length. The UE may be able to receive the PDCCH communication with the old TCI state until slot n+T_{HARQ}+(3 ms+T_{L1-RSRP}+TOᵤₖ*T_{first-SSB})/NR slot length. T_{L1-RSRP} may be the time for L1-RSRP measurement for receive beam refinement in FR2, defined as periodicity of the SSB/CSI-RS with respect to the TCI state. The T_{L1-RSPR_Measurement_Period_SSB} for SSB and T_{L1-RSRP_Measurement_Period_CSI-RS} for CSI-RS may be specified. TOᵤₖ may be 1 for CSI-RS based L1-RSRP measurement, and 0 for SSB based L1-RSRP measurement when TCI state switching involves QCL-TypeD. TOᵤₖ may be 1 when TCI state switching involves other QCL types.

For T_{L1-RSRP} for FR2, T_{L1-RSRP}=T_{L1-RSPR Measurement_Period_SSB} for SSB as specified in different configurations with the assumption of factor M=1, beam sweeping factor N=8, and T_{Report}=0. For a configuration for non-discontinuous reception (non-DRX), T_{L1-RSPR_Measurement_Period_SSB} may be the maximum (max) of T_{Report} and the ceiling value (ceil) of (M×P×N)×T_{SSB}. For the non-DRX configuration, it is assumed that the UE uses 8 SSB cycles to refine its transmit beam. For a configuration for DRX cycle ≤320 ms, T_{L1-RSPR_Measurement_Period_SSB} may be the maximum of T_{Report} and the ceiling value of ((1.5×M×P×N)×max(T_{DRX},T_{SSB})). For a configuration for DRX cycle >320 ms, T_{L1-RSPR_Measurement_Period_SSB} may be the ceiling value of ((1.5×M×P×N)×T_{DRX}). T_{SSB}=ssb-periodicityServingCell may be the periodicity of the SSB-Index configured for L1-RSRP measurement. T_{DRX} may be the DRX cycle length. T_{Report} may be a configured periodicity for reporting.

For T_{L1-RSRP} for FR2, T_{L1-RSRP}=T_{L1-RSPR_Measurement_Period_CSI-RS} for CSI-RS as specified in different configurations with the assumption of M=1 and T_{Report}=0. Higher layer parameter repetition may be set to on. For aperiodic CSI-RS, the quantity of resources in a resource set may be at least equal to MaxNumberRxBeam, which may be RRC configured per band and can vary from 2 to 8. N_{res_per_set} may be the quantity of CSI-RS resources within the considered CSI-RS resource set. For a configuration for non-DRX, T_{L1-RSPR_Measurement_Period_CSI-RS} may be the maximum (max) of T_{Report} and the ceiling value (ceil) of (M×P×N)×T_{CSI-RS}. For maxNumberRxBeam=N_{res_per_set}, the UE may be assumed to use one periodic or semi-periodic (P/SP) CSI-RS cycle to refine its receive beam. N may be ceil (maxNumberRxBeam/N_{res_per_set}) for P/SP-CSI-RS with repetition set to on. N may be 1 for AP CSI-RS assuming maxNumberRxBeam≤N_{res_per_set}. M may be 1 for P/SP CSI-RS. For a configuration for DRX cycle≤320 ms, T_{L1-RSPR_Measurement_Period_CSI-RS} may be the maximum of T_{Report} and the ceiling value of ((1.5×M×P×N)×max(T_{DRX}, T_{CSI-RS})). For a configuration for DRX cycle >320 ms, T_{L1-RSPR_Measurement_Period_CSI-RS} may be the ceiling value of ((M×P×N)×T_{DRX}). T_{CSI-RS} may be the periodicity of CSI-RS configured for L1-RSRP measurement. The requirements may be applicable provided that the CSI-RS resource configured for L1-RSRP measurement is transmitted with a density of 3.

As indicated above, FIG. 20 is provided as an example. Other examples may differ from what is described with regard to FIG. 20.

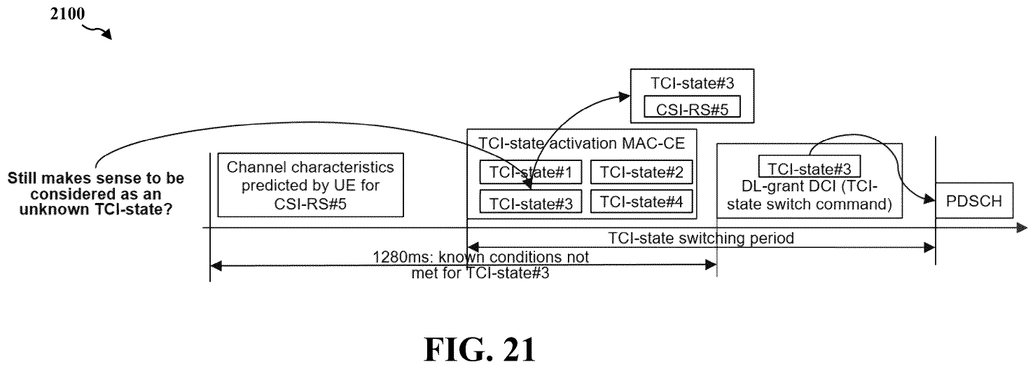

FIG. 21 is a diagram illustrating an example 2100 of predicting channel characteristics, in accordance with the present disclosure.

As shown by example 2100, the UE may have already predicted channel characteristics regarding a particular SSB or CSI-RS and a proper receive spatial filter (with respect to QCL-TypeA/C/D) related to such an SSB or CSI-RS, without actually measuring the SSB or CSI-RS. For example, for time domain beam prediction, the UE may predict future L1-RSRPs regarding SSBs, and optionally report the predicted L1-RSRPs without actually measuring them (against known TCI state condition #2). The UE may predict whether the strongest SSB is going to switch to another one for a future duration instead of a most recent L1 measurement report. If there is no change, the UE may simply do nothing. If a change is predicted, the UE may request an AP/SP L1-measurement report in an on-demand manner (against known TCI state condition #2). For spatial domain prediction, the UE may predict L1-RSRPs associated with CSI-RSs (e.g., with periodicity=2000 ms) based on SSBs (e.g., with periodicity=20 ms), without frequently measuring the CSI-RSs (against known TCI state condition #1). Such cases are considered to be unknown TCI-states, but some latencies are not necessary for such predictive beam management. For example, for SSB/CSI-RS, the UE may simply apply the predicted receive spatial filter, without measuring the SSB/CSI-RS. For CSI-RS, the UE may measure the SSB again to verify QCL-TypeA/C, and does not actually measure the CSI-RS.

In other words, while channel characteristics may be predicted, the TCI state may still be considered unknown under current known TCI state conditions. This can introduce more latency.

As indicated above, FIG. 21 is provided as an example. Other examples may differ from what is described with regard to FIG. 21.

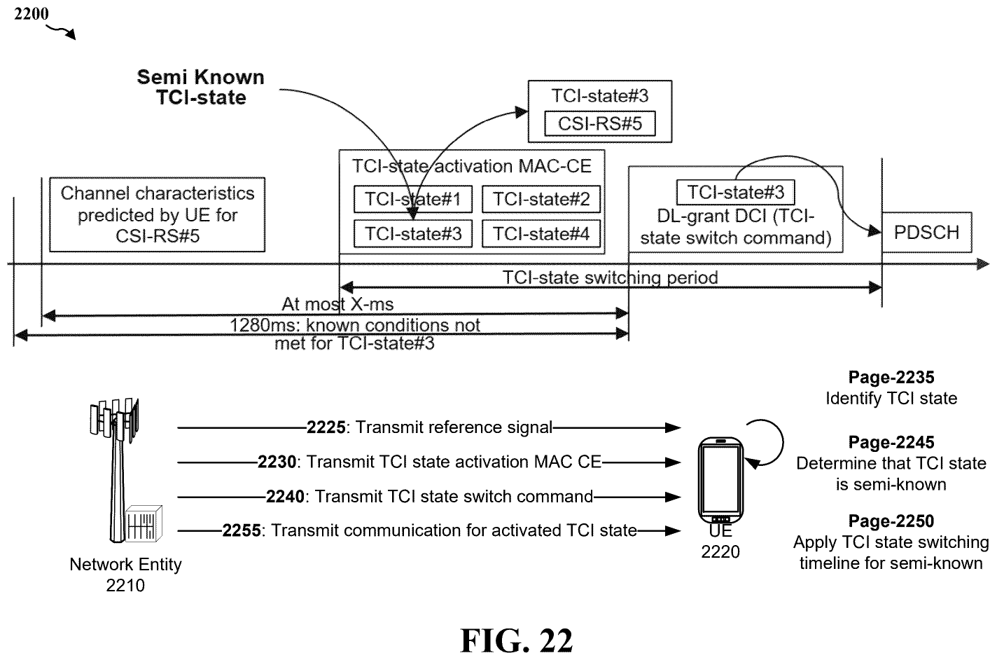

FIG. 22 is a diagram illustrating an example 2200 of using a semi-known TCI state, in accordance with the present disclosure. As shown in FIG. 22, a network entity 2210 (e.g., base station 110) and a UE 2220 (e.g., a UE 104) may communicate with one another.

According to various aspects described herein, the UE may use a semi-known TCI state status with respect to CSI-RS/SSB channel characteristic prediction. The TCI state may be semi-known when channel characteristics do not meet a known TCI state condition but meet a prediction condition. The prediction condition may be met if channel characteristics are predicted within a prediction time duration. If an activated TCI state is semi-known, the UE may use a TCI state switching timeline that is specific to the semi-known status. In this way, the predicted channel characteristics may be used to reduce latency instead of faulting to the longer TCI state switching timeline for unknown TCI states. For example, the TCI state switching timeline for semi-known TCI states may remove the L1-Alternatively, the UE may fall back to the known TCI state status if a known TCI state condition is not met but the prediction condition is met.

Example 2200 shows use of a semi-known TCI state (e.g., TCI state #3). As shown by reference number 2225, the network entity 2210 may transmit a reference signal (e.g., CSI-RS, SSB). As shown by reference number 2230, the network entity 2210 may transmit a TCI state activation command (e.g., MAC CE). As shown by reference number 2235, the UE 2220 may identify the TCI state. The UE 2220 may identify the TCI state based at least in part on the TCI state activation command MAC CE that activates or updates the TCI state. The UE 2220 may identify the TCI state from an earlier MAC CE. The UE 2220 may identify the TCI state from among TCI states that are in an activated TCI state list. The UE 2220 may identify the TCI state from among TCI states that are outside the activated TCI state list. As shown by reference number 2240, the network entity 2210 may transmit a TCI state switch command (e.g., downlink control information (DCI)).

As shown by reference number 2245, the UE 2220 may determine that the TCI state is semi-known. That is, the UE 2220 may determine that known conditions are not met for TCI state #3. For example, the TCI state switch command may be received beyond a time period (e.g., 1280 ms) after receiving the reference signal (e.g., CSI-RS #5) and the UE 2220 has not transmitted a (convention) L1-RSRP report for the target TCI state before the TCI state switch command. However, a prediction condition is met. The UE 2220 has predicted channel characteristics associated with the reference signal in the TCI state (or QCLed with the RS) within a prediction duration.

The predication duration may be configured to be X ms before receiving the TCI state switch command associated with the TCI state. The value of the prediction duration may be configured for a specific prediction scenario, and different values of the prediction duration may be used for different prediction scenarios. For example, one scenario (e.g., beam change prediction/report) may be more suitable for semi-static environments, such that the prediction duration is longer for this scenario than for other scenarios. The different values may be specified in a standard, configured by the network entity 2210, or indicated by the network entity 2210 via an RRC message, a MAC CE, or DCI. The UE 2220 may also transmit a preferred value for the prediction duration.

In some aspects, the channel characteristics may include a predicted L1-RSRP that is reported without actually receiving the RS or measuring the RS. For example, the UE 2220 may measure SSBs (e.g., periodicity=20 ms) and not CSI-RS to identify or report L1-RSRPs of CSI-RSs (e.g., periodicity of 2000 ms). The channel characteristics may be based at least in part on transmitting a preference for using the RS resource as a Type D QCL source without transmitting an L1-RSRP report. For example, the UE 2220 may report an SSB resource indicator (SSBRI) as a preferred TypeD-QCL source without reporting its L1-RSRP. The channel characteristics may be based at least in part on the preference of using the reference signal as a TypeD-QCL source (without transmitting the preference). For example, the UE 2220 may transmit an L1-RSRP report for SSB #3 comprising the strongest L1-RSRP at slot n, and the UE 2220 may request actual L1-RSRP reports if the UE 2220 determines that the strongest SSB would change to another SSB. The UE 2220 may indicate the preference of using the SSB #3 as TypeD-QCL source without actually reporting its L1-RSRP (which is agreed between the UE 2220 and the network entity 2210).

As shown by reference number 2250, the UE 2220 may apply the TCI state switching timeline for semi-known TCI states. The TCI state switching timeline may affect the delay or time between the slot in which the TCI state activation command (MAC-CE) is received and the first TCI state switch command (DCI) associated with the TCI-state. There may be priority rules between semi-known and unknown. If a TCI state can be considered to be semi-known at a particular time, the TCI state may not be considered to be unknown until the conditions for semi-known are no longer met.

The UE 2220 and the network entity may apply the TCI state switch according to the TCI state switching timeline for semi-known TCI states. As shown by reference number 2255, the network entity 2210 may transmit a communication (e.g., on the PDSCH) using the activated TCI state. The UE 2220 may receive the communication using the activated TCI state. By using a TVCI state switching timeline for semi-known states, latency may be reduced.

In some aspects, the UE 2220 may indicate (applicability indication) whether the semi-known TCI states are applicable to the UE 2220. For example, if the UE 2220 identifies that a reference signal in the TCI state is applicable to semi-known conditions, the UE 2220 may assume that the TCI state is applicable to semi-known states. That is, the UE 2220 may determine that the TCI state is capable of being a semi-known TCI state without signaling from the network entity 2210.

In some aspects, the UE 2220 may determine that the TCI state is capable of being a semi-known TCI state based at least in part on signaling from the network entity 2210. The network entity 2210 may control the use of semi-known TCI states. The network entity 2210 may indicate to UE 2220 that a TCI state is applicable to semi-known states. For example, the network entity 2210 may configure, via an RRC configuration for a TCI state or the TCI state activation command, whether semi-known states can be assumed or used by the UE 2220 (can overwrite other RRC configurations for TCI state states). The network entity 2210 may also configured the UE 2220 using a MAC CE to dedicatedly activate the TCI states that can be applicable to semi-known states. The network entity 2210 may indicate the TCI states activated by such a MAC CE in DCI (with corresponding dedicated radio network temporary identifiers (RNTIs) or DCI formats). For example, DCI may further indicate the indicated TCI state identifiers (IDs) that are related to types of TCI state activation commands.

In some aspects, the UE 2220 may report whether a TCI state is applicable to semi-known states. The UE 2220 may report a preference (preference indication) for which RRC configured TCI states can be assumed to be semi-known states. The UE 2220 may report, together with an acknowledgement (ACK) regarding the TCI state activation MAC CE, UE reports for one or more of the TCI states activated by the MAC CE and whether semi-known states can be assumed. This can be further based on overwriting an MAC CE indication through such UE reporting. The UE 2220 may report its preference on the value of X (e.g., different values of X for different scenarios).

As indicated above, FIG. 22 is provided as an example. Other examples may differ from what is described with respect to FIG. 22.

For example, a timeline for applying a TCI state, e.g., after the indication of the TCI state at 1820 may be based on whether the TCI state is a known state, a semi-known state or an unknown TCI state. If the known TCI state conditions are not met while the prediction conditions are met (considering whether the Rx beam has been addressed in a L1 report), the TCI state in may be considered as a semi-known TCI state. For example, the base station may help with predicting the Rx beam and may indicate the TCI state that comprises an Rx beam ID, although UE did not yet report a L1-RSRP/L1-SINR associated with the Rx beam, as the UE may have explicitly reported the 1^{st} number of Rx beams in the capability report. The UE may apply a timeline parameter, such as X ms for communication based on a semi-known TCI state after it is indicated by the base station. The timeline parameter may be defined, configured by the base station or reported by the UE.

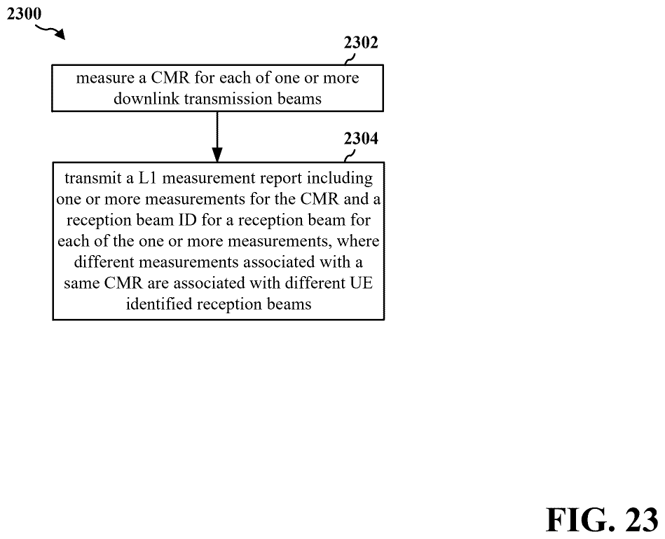

FIG. 23 is a flowchart 2300 of a method of wireless communication. The method may be performed by a UE (e.g., the UE 104, the UE 350, the UE 504, the apparatus 2504). In an example, the method (including the various configurations described below) may be performed by the L1 report component 198 described above. The method may be associated with various advantages for the UE, such as reduced UE power consumption and reduced latency (described in greater detail above). At 2302, the UE measures a CMR for each of one or more downlink transmission beams. For example, referring to FIG. 6, the UE generates L1-RSRP time series measurements 602 for one or more CSI-RS or SSB.

At 2304, the UE transmits a L1 measurement report including one or more measurements for the CMR and a reception beam ID for a reception beam for each of the one or more measurements, where different measurements associated with a same CMR are associated with different UE identified reception beams. For example, referring to FIG. 8, the UE transmits the enhanced L1 report 802 that is based upon beam pairs and the enhanced L1 report 802 includes identifiers for Rx beams (e.g., the identifier for the third Rx beam 808).

In one configuration, the CMR may comprise at least one of a CSI-RS resources or a SSB resources, and each of the one or more measurements includes at least one of an L1-RSRP measurement or an L1-SINR measurement. For example, referring to FIG. 8, the enhanced L1 report 802 includes L1-RSRP measurements (e.g., L1-RSRP measurement 812).

In one configuration, the UE may transmit, prior to the L1 measurement report, information identifying a first set of reception beams at the UE. The UE may receive a configuration for the L1 measurement report indicating for the UE to report an L1 measurement for a second set of reception beams, the second set of reception beams including at least a subset of the first set of reception beams at the UE. In such a configuration, the reception beam ID for the reception beam for each of the one or more measurements is based on the second set of reception beams indicated in the configuration. For example, referring to FIG. 9, the UE may transmit the first UE Rx beam information 902. The UE may receive a configuration for the L1 measurement report indicating that the UE is to report an L1 measurement for second Rx beams (e.g., beams corresponding to Rx beam identifier 910, Rx beam identifier 916, and Rx beam identifier 918).

In one configuration, the information identifying the first set of reception beams at the UE includes at least one of beam pointing directions or beam width information. For example, referring to FIG. 9, the first UE Rx beam information 902 may include information about beam pointing directions or beam width.

In one configuration, the configuration may be for a semi-persistent CSI report and the second set of reception beams is identified in a MAC-CE activating the semi-persistent CSI report. For example, referring to FIG. 9, the UE may be configured via MAC-CE (activating SP CSI report) to generate report configuration 922, where the report configuration 922 corresponds to a second number of Rx beams.

In one configuration, the configuration is for an aperiodic CSI report and the second set of reception beams is identified in the configuration for the aperiodic CSI report. For example, referring to FIG. 9, the UE may be configured via triggering AP CSI report 920 to generate report configuration 922, where the report configuration 922 corresponds to a second number of Rx beams.

In one configuration, the L1 measurement report may include an absolute value of a first measurement for a first transmission and reception beam pair, and a differential value for each of one or more beam pairs, the differential value being relative to the absolute value for the first transmission and reception beam pair. For example, referring to FIG. 10, the UE may report an absolute L1-RSRP measurement 1002 and differential L1-RSRP measurements 1004, 1006, 1008.

In one configuration, the L1 measurement report may include an absolute value of a first measurement for a first beam pair for a first CMR, a first differential value for a second CMR using a first receive beam, the first differential value being relative to the absolute value for the first CMR, and a second differential value for the second CMR using a second receive beam, the second differential value being relative to the first differential value. For example, referring to FIG. 11, the UE may report an absolute L1-RSRP measurement 1102 corresponding to a strongest beam pair among all CMRs, a differential L1-RSRP measurement 1104 that is relative to the absolute L1-RSRP 1102 and that is for a CMR that is for a different than the CMR corresponding to the absolute L1-RSRP measurement 1102, and a differential measurement 1110 that is relative to the differential L1-RSRP measurement 1104 and that corresponds to the CMR used for the differential L1-RSRP measurement 1104.

In one configuration, the UE may report a CMR identifier ID and a receive beam ID for each of the one or more measurements included in the L1 measurement report. For example, referring to FIG. 8, the enhanced L1-RSRP report includes an identifier for a first CMR 804, an identifier for a third Rx beam 808, and a L1-RSRP measurement 812.

In one configuration, the UE may receive a configuration to report different numbers of beam pair measurements for different CMRs. For example, referring to FIG. 8, the UE may receive a configuration to report beam pairs for a first CMR 804 and a fourth CMR 806.

In one configuration, the UE may compress a payload of the L1 measurement report. In such a configuration, compressing the payload may include at least one of encoding a first component of the L1 measurement report using a first encoder and encoding a second component of the L1 measurement report using a second encoder, performing a variable length compression of the payload of the L1 measurement report and reporting a variable payload size using a fixed number of bits, or encoding the payload of the L1 measurement report based on an indication from a network entity of at least one of a decoder or an encoder. For example, referring to FIG. 12, the UE may provide the L1-RSRPs and/or L1-SINRs 1204 as input to a first encoder 1208. The first encoder 1208 generates encoded L1-RSRPs/L1-SINRs 1210 based upon the L1-RSRPs and/or L1-SINRs 1204. The UE may also provide the CMR identifiers and Rx-beam identifiers 1206 as input to a second encoder 1212. The second encoder 1212 generates encoded CMR identifiers and Rx-beam identifiers 1214 based upon the CMR identifiers and Rx-beam identifiers 1206. For example, referring to FIG. 13, in the first scheme 1302, an input length of the compressed/uncompressed payload is variable and an output length is fixed.

In one configuration, the first encoder may compress the one or more measurements in the L1 measurement report, and the second encoder may compress at least one of a CMR ID or a receive beam ID. For example, referring to FIG. 12, the UE may provide the L1-RSRPs and/or L1-SINRs 1204 as input to a first encoder 1208 and the first encoder compresses the L1-RSRPs and/or L1-SINRs 1204 and the UE may also provide the CMR identifiers and Rx-beam identifiers 1206 as input to a second encoder 1212 that compresses the CMR identifiers and Rx-beam identifiers 1206.

In one configuration, a first portion of an L1 measurement payload may be reported in a first CSI part, and a second portion of the L1 measurement payload may be reported in a second CSI part. For example, referring to FIG. 14, the UE may partition the payload 1402 into a first CSI part 1404 and a second CSI part 1406.

In one configuration, the first CSI part may include a strongest L1 measurement for the CMR based on a first receive beam, and the second CSI part may include at least one additional L1 measurement for the CMR based on at least one additional receive beam. For example, referring to FIG. 14, the first CSI part 1404 includes the legacy L1 report 1408 that includes strongest L1-RSRP/L1-SINR measurements for each downlink CMR. The second CSI part 1406 includes remaining components/information 1412. The remaining components/information 1412 may include one or more additional L1 measurements for the CMR based on another receive beam.

In one configuration, the first CSI part may indicate a payload size of the second portion of the L1 measurement payload in the second CSI part. For example, referring to FIG. 15, the first CSI part 1504 includes a non-compressed L1 report payload size or a compressed payload size 1508.

In one configuration, a first measurement for the CMR and a first receive beam may be reported in a first CSI report, and at least one additional L1 measurement for the CMR based on at least one additional receive beam may be reported in a second CSI report. For example, referring to FIG. 16, the UE, via multiple CSI report settings, is configured to generate L1 reports 1604 and remaining components 1606. Each L1 report in the L1 reports 1604 may include a strongest L1-RSRP/L1-SINR measurement for each downlink CMR together with an identifier for a respective CMR (which may be referred to as a first CSI report). Each remaining component (which may be referred to as a second CSI report) in the remaining components 1606 comprises an enhanced L1 report (e.g., the enhanced L1 report 802).

In one configuration, the first CSI may have a different periodicity than the second CSI report. For example, referring to FIG. 16, in one aspect, the UE reports the L1 reports 1604 at a first periodicity and the remaining components 1606 at a second periodicity, where the first periodicity is less than the second periodicity. A most recent first CSI report may serve as a reference for a second CSI report.

In one configuration, the UE may receive a configuration of a set of TCI states having a QCL relationship to at least one receive beam at the UE. The UE may receive an activation of at least one TCI state from the set of TCI states. The UE may communicate with a network entity using at least one receive beam having the QCL relationship to the at least one TCI state activated for the UE. For example, referring to FIG. 17, a UE (e.g., the UE 104, the UE 350, the UE 504) may be configured with a first number of TCI states, where the TCI state 1702 is included in the first number of TCI states. The TCI state 1702 includes QCL information 1704. The QCL information 1704 includes a UE Rx beam identifier 1706 along with UE Rx beam information (which may be based on the enhanced L1 report 802 described above).

In one configuration, the UE may apply a switching timeline based on the at least one TCI state meeting a first set of conditions for a known state or a second set of conditions for a partially known state. For example, referring to FIGS. 19 and 20, examples of switching timelines are described.

In one configuration, the first set of conditions for the known state may include a TCI state switch command is received within a time period after a last reference signal for beam reporting or measurement, at least one Layer 1 reference signal received power report is transmitted for the TCI state before receiving the TCI state switch command, the TCI state remains detectable during a TCI state switching period, and a synchronization signal block associated with the TCI state remains detectable during the TCI state switching period. For example, referring to FIGS. 19 and 22, examples of the first set of conditions are described.

In one configuration, the second set of conditions for the partially known state may be based on the first set of conditions except for at least one of the UE does not perform measurements of SSBs or CSI-RSs after a slot in which a TCI state activation is received and before receiving DCI identifying the TCI state, the UE performs the measurement of the SSBs and does not measure the CSI-RSs after the slot in which the TCI state activation is received and before receiving the DCI identifying the TCI state, or the UE performs the measurement of the SSBs and does not measure the CSI-RSs after the slot in which the TCI state activation is received and before receiving the DCI identifying the TCI state. For example, referring to FIGS. 19-22, examples of the second set of conditions are described.

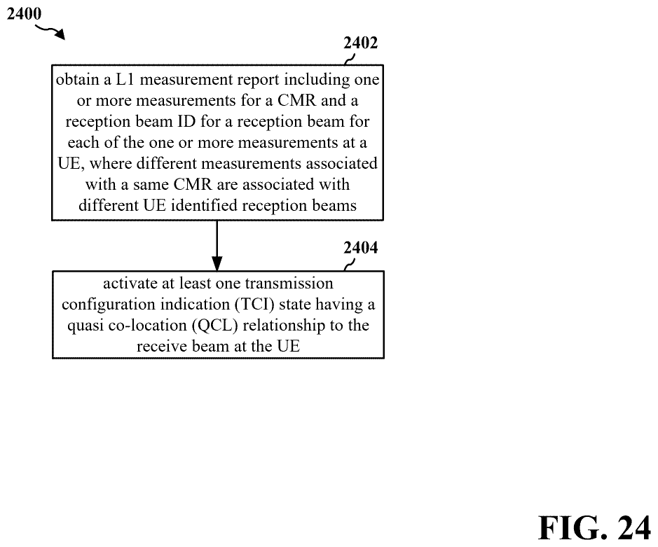

FIG. 24 is a flowchart 2400 of a method of wireless communication. The method may be performed by a network node (e.g., the base station 102, the base station 310, the base station 502, the network entity 2602). In an example, the method (including the various configurations described below) may be performed by the reception beam indication component 199 described above. The method may be associated with various advantages for the network node, such as more accurate beam pair prediction (described in greater detail above). At 2402, the network node obtains a L1 measurement report including one or more measurements for a CMR and a reception beam ID for a reception beam for each of the one or more measurements at a user equipment (UE), where different measurements associated with a same CMR are associated with different UE identified reception beams. For example, referring to FIG. 8, the base station obtains the enhanced L1 report 802 and the enhanced L1 report 802 includes identifiers for Rx beams.

At 2404, the network node activates at least one TCI state having a QCL relationship to the receive beam at the UE. For example, referring to FIG. 17, the network node activates the TCI state 1702. The TCI state 1702 includes QCL information 1704.

In one configuration, the network node may configure a set of TCI states having a QCL relationship to at least one receive beam at the UE. In such an aspect, the at least one TCI state is activated from the set of TCI states configured for the UE. For example, referring to FIG. 17, the TCI state 1702 may part of a set of TCI states having a QCL relationship to a receive beam at the UE.

In one configuration, the CMR may comprise at least one of a CSI-RS resources or a SSB resources. In such an aspect, each of the one or more measurements includes at least one of an L1-RSRP measurement or an L1-SINR measurement. For example, referring to FIG. 8, the enhanced L1 report 802 includes L1-RSRP measurements for different CMRs.

In one configuration, the network node may obtain, prior to the L1 measurement report, information identifying a first set of reception beams at the UE. In such a configuration, the network node may output a configuration for the L1 measurement report indicating for the UE to report an L1 measurement for a second set of reception beams, the second set of reception beams including at least a subset of the first set of reception beams at the UE. The reception beam ID for the reception beam for each of the one or more measurements is based on the second set of reception beams indicated in the configuration. For example, referring to FIG. 9, the network node may obtain the first UE Rx beam information 902. The network node may output the report configuration 922.

In one configuration, the information identifying the first set of reception beams at the UE includes at least one of beam pointing directions or beam width information. For example, referring to FIG. 9, the first UE Rx beam information 902 may include information about beam pointing directions or beam width.

In one configuration, the configuration may be for a semi-persistent CSI report and the second set of reception beams is identified in a MAC-CE activating the semi-persistent CSI report. For example, referring to FIG. 9, the configuration may be for a SP CSI report.

In one configuration, the configuration may be for an aperiodic CSI report and the second set of reception beams is identified in the configuration for the aperiodic CSI report. For example, referring to FIG. 9, the configuration may be for a AP CSI report.

In one configuration, the L1 measurement report may include an absolute value of a first measurement for a first transmission and reception beam pair and a differential value for each of one or more beam pairs, the differential value being relative to the absolute value for the first transmission and reception beam pair. For example, referring to FIG. 10, the network node may obtain an absolute L1-RSRP measurement 1002 and differential L1-RSRP measurements 1004, 1006, 1008.

In one configuration, the L1 measurement report may include an absolute value of a first measurement for a first beam pair for a first CMR, a first differential value for a second CMR using a first receive beam, the first differential value being relative to the absolute value for the first CMR, and a second differential value for the second CMR using a second receive beam, the second differential value being relative to the first differential value. For example, referring to FIG. 11, the network node may obtain an absolute L1-RSRP measurement 1102 corresponding to a strongest beam pair among all CMRs, a differential L1-RSRP measurement 1104 that is relative to the absolute L1-RSRP 1102 and that is for a CMR that is for a different than the CMR corresponding to the absolute L1-RSRP measurement 1102, and a differential measurement 1110 that is relative to the differential L1-RSRP measurement 1104 and that corresponds to the CMR used for the differential L1-RSRP measurement 1104.

In one configuration, the L1 measurement report may include a CMR identifier (ID) and a receive beam ID for each of the one or more measurements included in the L1 measurement report. For example, referring to FIG. 8, the enhanced L1-RSRP report includes an identifier for a first CMR 804, an identifier for a third Rx beam 808, and a L1-RSRP measurement 812.

In one configuration, the network node may output a configuration to report different numbers of beam pair measurements for different CMRs. For example, referring to FIG. 8, the network node may output a configuration to report beam pairs for a first CMR 804 and a fourth CMR 806.

In one configuration, a payload of the L1 measurement report may be compressed based on at least one of a first component of the L1 measurement report encoded using a first encoder and a second component of the L1 measurement report encoded using a second encoder, a variable length compression of the payload of the L1 measurement report and an indication of a variable payload size using a fixed number of bits, or the payload of the L1 measurement report encoded based on an indication from a network entity of at least one of a decoder or an encoder. For example, referring to FIG. 12, the L1-RSRPs and/or L1-SINRs 1204 may be provided as input to a first encoder 1208. The first encoder 1208 generates encoded L1-RSRPs/L1-SINRs 1210 based upon the L1-RSRPs and/or L1-SINRs 1204. The CMR identifiers and Rx-beam identifiers 1206 as input to a second encoder 1212. The second encoder 1212 generates encoded CMR identifiers and Rx-beam identifiers 1214 based upon the CMR identifiers and Rx-beam identifiers 1206. For example, referring to FIG. 13, in the first scheme 1302, an input length of the compressed/uncompressed payload is variable and an output length is fixed.

In one configuration, a first portion of an L1 measurement payload may be reported in a first CSI part, and a second portion of the L1 measurement payload may be reported in a second CSI part. For example, referring to FIG. 14, the payload 1402 may be reported in a first CSI part 1404 and a second CSI part 1406.

In one configuration, the first CSI part may include a strongest L1 measurement for the CMR based on a first receive beam, and the second CSI part may include at least one additional L1 measurement for the CMR based on at least one additional receive beam. The first CSI part 1404 includes the legacy L1 report 1408 that includes strongest L1-RSRP/L1-SINR measurements for each downlink CMR. The second CSI part 1406 includes remaining components/information 1412. The remaining components/information 1412 may include one or more additional L1 measurements for the CMR based on another receive beam.

In one configuration, the first CSI part may indicate a payload size of the second portion of the L1 measurement payload in the second CSI part. For example, referring to FIG. 15, the first CSI part 1504 includes a non-compressed L1 report payload size or a compressed payload size 1508.

In one configuration, a first measurement for the CMR and a first receive beam may be reported in a first CSI report, and at least one additional L1 measurement for the CMR based on at least one additional receive beam is reported in a second CSI report. For example, referring to FIG. 16, the network node may obtain L1 reports 1604 and remaining components 1606. Each L1 report in the L1 reports 1604 may include a strongest L1-RSRP/L1-SINR measurement for each downlink CMR together with an identifier for a respective CMR (which may be referred to as a first CSI report). Each remaining component (which may be referred to as a second CSI report) in the remaining components 1606 comprises an enhanced L1 report (e.g., the enhanced L1 report 802).

In one configuration, the first CSI report may have a different periodicity than the second CSI report. For example, referring to FIG. 16, in one aspect, the L1 reports 1604 are reported at a first periodicity and the remaining components 1606 are reported at a second periodicity, where the first periodicity is less than the second periodicity. A most recent first CSI report may serve as a reference for a second CSI report.

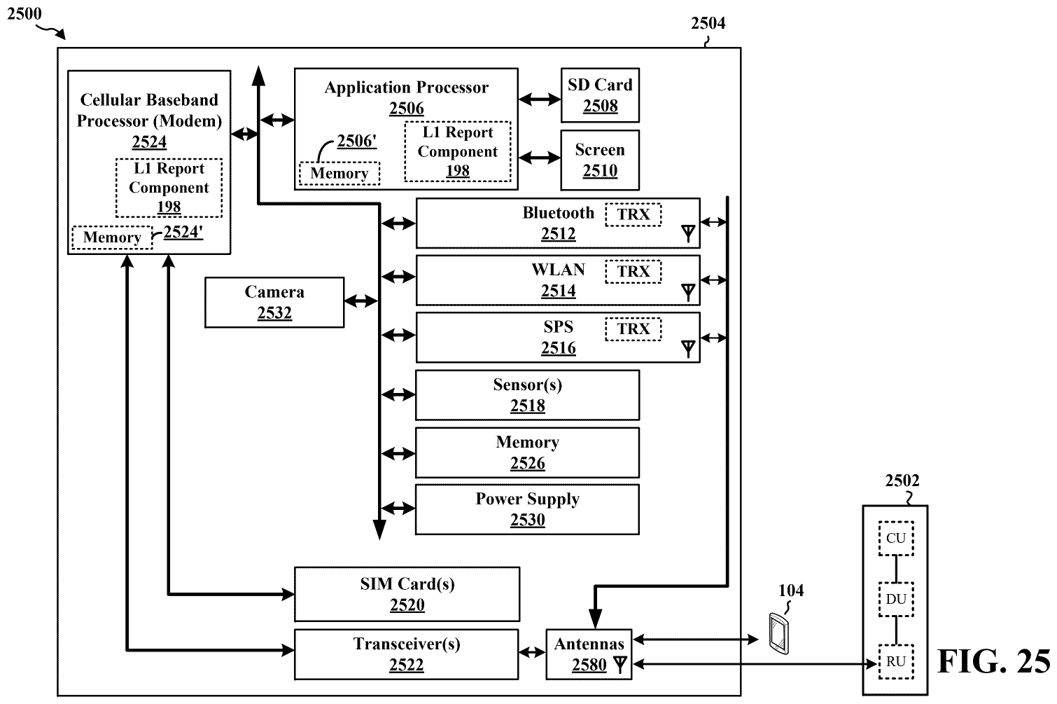

FIG. 25 is a diagram 2500 illustrating an example of a hardware implementation for an apparatus 2504. The apparatus 2504 may be a UE, a component of a UE, or may implement UE functionality. In some aspects, the apparatus 2504 may include a cellular baseband processor 2524 (also referred to as a modem) coupled to one or more transceivers 2522 (e.g., cellular RF transceiver). The cellular baseband processor 2524 may include on-chip memory 2524′. In some aspects, the apparatus 2504 may further include one or more subscriber identity modules (SIM) cards 2520 and an application processor 2506 coupled to a secure digital (SD) card 2508 and a screen 2510. The application processor 2506 may include on-chip memory 2506′. In some aspects, the apparatus 2504 may further include a Bluetooth module 2512, a WLAN module 2514, an SPS module 2516 (e.g., GNSS module), one or more sensor modules 2518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2526, a power supply 2530, and/or a camera 2532. The Bluetooth module 2512, the WLAN module 2514, and the SPS module 2516 may include an on-chip transceiver (TRX) (or in some cases, just a receiver (RX)). The Bluetooth module 2512, the WLAN module 2514, and the SPS module 2516 may include their own dedicated antennas and/or utilize the antennas 2580 for communication. The cellular baseband processor 2524 communicates through the transceiver(s) 2522 via one or more antennas 2580 with the UE 104 and/or with an RU associated with a network entity 2502. The cellular baseband processor 2524 and the application processor 2506 may each include a computer-readable medium/memory 2524′, 2506′, respectively. The additional memory modules 2526 may also be considered a computer-readable medium/memory. Each computer-readable medium/memory 2524′, 2506′, 2526 may be non-transitory. The cellular baseband processor 2524 and the application processor 2506 are each responsible for general processing, including the execution of software stored on the computer-readable medium/memory. The software, when executed by the cellular baseband processor 2524/application processor 2506, causes the cellular baseband processor 2524/application processor 2506 to perform the various functions described supra. The computer-readable medium/memory may also be used for storing data that is manipulated by the cellular baseband processor 2524/application processor 2506 when executing software. The cellular baseband processor 2524/application processor 2506 may be a component of the UE 350 and may include the memory 360 and/or at least one of the TX processor 368, the RX processor 356, and the controller/processor 359. In one configuration, the apparatus 2504 may be a processor chip (modem and/or application) and include just the cellular baseband processor 2524 and/or the application processor 2506, and in another configuration, the apparatus 2504 may be the entire UE (e.g., see 350 of FIG. 3) and include the additional modules of the apparatus 2504.

As discussed supra, the L1 report component 198 is configured to measure a CMR for each of one or more downlink transmission beams and transmit a L1 measurement report including one or more measurements for the CMR and a reception beam identifier (ID) for a reception beam for each of the one or more measurements, where different measurements associated with a same CMR are associated with different UE identified reception beams. The L1 report component 198 may be within the cellular baseband processor 2524, the application processor 2506, or both the cellular baseband processor 2524 and the application processor 2506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2504 may include a variety of components configured for various functions. In one configuration, the apparatus 2504, and in particular the cellular baseband processor 2524 and/or the application processor 2506, includes means for measuring a CMR for each of one or more downlink transmission beams and a means for transmitting a layer 1 (L1) measurement report including one or more measurements for the CMR and a reception beam identifier (ID) for a reception beam for each of the one or more measurements, wherein different measurements associated with a same CMR are associated with different UE identified reception beams. The means may be the L1 report component 198 of the apparatus 2504 configured to perform the functions recited by the means. As described supra, the apparatus 2504 may include the TX processor 368, the RX processor 356, and the controller/processor 359. As such, in one configuration, the means may be the TX processor 368, the RX processor 356, and/or the controller/processor 359 configured to perform the functions recited by the means.

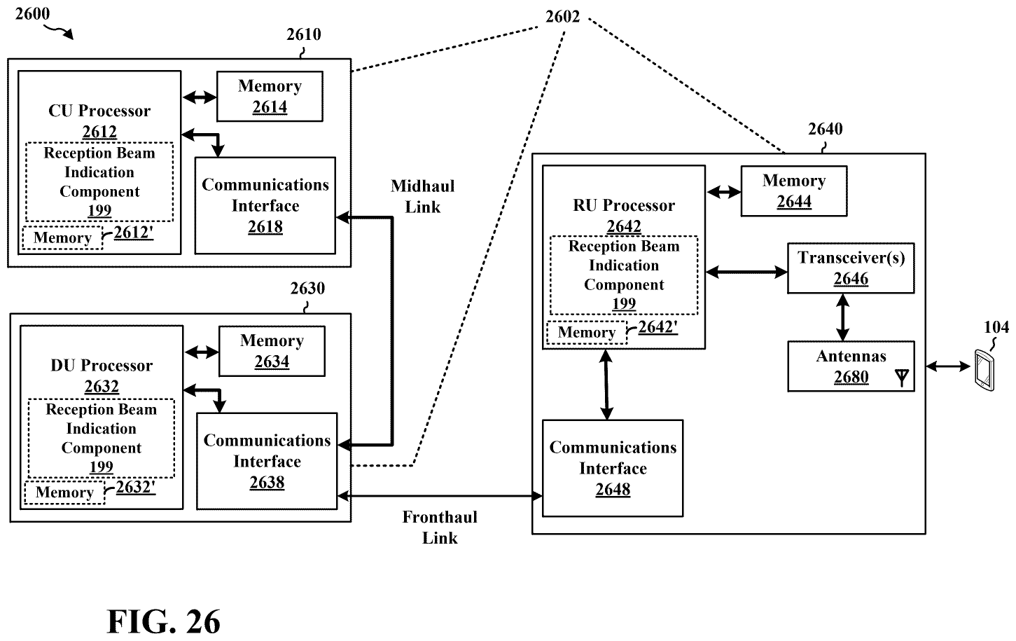

FIG. 26 is a diagram 2600 illustrating an example of a hardware implementation for a network entity 2602. The network entity 2602 may be a BS, a component of a BS, or may implement BS functionality. The network entity 2602 may include at least one of a CU 2610, a DU 2630, or an RU 2640. For example, depending on the layer functionality handled by the reception beam indication component 199, the network entity 2602 may include the CU 2610; both the CU 2610 and the DU 2630; each of the CU 2610, the DU 2630, and the RU 2640; the DU 2630; both the DU 2630 and the RU 2640; or the RU 2640. The CU 2610 may include a CU processor 2612. The CU processor 2612 may include on-chip memory 2612′. In some aspects, the CU 2610 may further include additional memory modules 2614 and a communications interface 2618. The CU 2610 communicates with the DU 2630 through a midhaul link, such as an F1 interface. The DU 2630 may include a DU processor 2632. The DU processor 2632 may include on-chip memory 2632′. In some aspects, the DU 2630 may further include additional memory modules 2634 and a communications interface 2638. The DU 2630 communicates with the RU 2640 through a fronthaul link. The RU 2640 may include an RU processor 2642. The RU processor 2642 may include on-chip memory 2642′. In some aspects, the RU 2640 may further include additional memory modules 2644, one or more transceivers 2646, antennas 2680, and a communications interface 2648. The RU 2640 communicates with the UE 104. The on-chip memory 2612′, 2632′, 2642′ and the additional memory modules 2614, 2634, 2644 may each be considered a computer-readable medium/memory. Each computer-readable medium/memory may be non-transitory. Each of the processors 2612, 2632, 2642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the reception beam indication component 199 is configured to obtain a L1 measurement report including one or more measurements for a CMR and identify a reception beam at a UE for each of the one or more measurements and activate at least one TCI state having a QCL relationship to the receive beam at the UE. The reception beam indication component 199 may be within one or more processors of one or more of the CU 2610, DU 2630, and the RU 2640. The reception beam indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2602 may include a variety of components configured for various functions. In one configuration, the network entity 2602 includes means for obtaining a L1 measurement report including one or more measurements for a CMR and identifying a reception beam at a UE for each of the one or more measurements and a means for activating at least one TCI state having a QCL relationship to the receive beam at the UE. The means may be the reception beam indication component 199 of the network entity 2602 configured to perform the functions recited by the means. As described supra, the network entity 2602 may include the TX processor 316, the RX processor 370, and the controller/processor 375. As such, in one configuration, the means may be the TX processor 316, the RX processor 370, and/or the controller/processor 375 configured to perform the functions recited by the means.

As discussed above, a UE may be configured to report beam qualities in the form of a report that is provided to a gNB. However, the report transmitted to the gNB by the UE may not have information pertaining to which received (Rx) beams the UE has measured regarding a particular transmission (Tx) beam, which may negatively impact predictive beam management efforts. To address this issue, an enhanced L1 report for gNB aided beam pair prediction is described herein. For instance, a UE measures a channel measurement resource (CMR) for each of one or more downlink transmission beams. The UE transmits a L1 measurement report (i.e., an enhanced L1 report) including one or more measurements for the CMR and a reception beam identifier (ID) for a reception beam for each of the one or more measurements, wherein different measurements associated with a same CMR are associated with different UE identified reception beams. Through utilizing enhanced L1 reports for ML model training purposes and at inference, such enhanced L1 reports can reduce a number of beams swept during beam sweeping and aid in gNB aided beam pair prediction. As such, the enhanced L1 report can reduce latency and UE power consumption. Additionally, the UE can compress the enhanced L1 report using differential measurements and/or using encoders, which can reduce a size of the enhanced L1 report, leading to more efficient use of network resources. In addition to compression, the UE can partition the enhanced L1 report into a first CSI part and a second CSI part, which may further reduce overhead. Moreover, in addition to compression, the UE can generate multiple CSI reports that are transmitted at different periodicities, which may further reduce overhead. Additionally, information pertaining to the enhanced L1 report can be utilized in TCI state activation/switching. It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: measuring a channel measurement resource (CMR) for each of one or more downlink transmission beams; and transmitting a layer 1 (L1) measurement report including one or more measurements for the CMR and a reception beam identifier (ID) for a reception beam for each of the one or more measurements, where different measurements associated with a same CMR are associated with different UE identified reception beams.

Aspect 2 is the method of aspect 1, where the CMR comprises at least one of a channel state information reference signal (CSI-RS) resources or a synchronization signal block (SSB) resources, and each of the one or more measurements includes at least one of an L1-reference signal received power (L1-RSRP) measurement or an L1-signal to interference and noise ratio (L1-SINR) measurement.

Aspect 3 is the method of any of aspects 1-2, further comprising: transmitting, prior to the L1 measurement report, information identifying a first set of reception beams at the UE; and receiving a configuration for the L1 measurement report indicating for the UE to report an L1 measurement for a second set of reception beams, the second set of reception beams including at least a subset of the first set of reception beams at the UE, where the reception beam ID for the reception beam for each of the one or more measurements is based on the second set of reception beams indicated in the configuration.

Aspect 4 is the method of any of aspects 1-3, where the information identifying the first set of reception beams at the UE includes at least one of beam pointing directions or beam width information.

Aspect 5 is the method of any of aspects 1-4, where the configuration is for a semi-persistent channel state information (CSI) report and the second set of reception beams is identified in a medium access control-control element (MAC-CE) activating the semi-persistent CSI report.

Aspect 6 is the method of any of aspects 1-4, where the configuration is for an aperiodic channel state information (CSI) report and the second set of reception beams is identified in the configuration for the aperiodic CSI report.

Aspect 7 is the method of any of aspects 1-6, where the L1 measurement report includes: an absolute value of a first measurement for a first transmission and reception beam pair, and a differential value for each of one or more beam pairs, the differential value being relative to the absolute value for the first transmission and reception beam pair.

Aspect 8 is the method of any of aspects 1-6, where the L1 measurement report includes: an absolute value of a first measurement for a first beam pair for a first CMR, a first differential value for a second CMR using a first receive beam, the first differential value being relative to the absolute value for the first CMR, and a second differential value for the second CMR using a second receive beam, the second differential value being relative to the first differential value.

Aspect 9 is the method of any of aspects 1-8, where the UE reports a CMR ID and a receive beam ID for each of the one or more measurements included in the L1 measurement report.

Aspect 10 is the method of any of aspects 1-9, further comprising: receiving a configuration to report different numbers of beam pair measurements for different CMRs.

Aspect 11 is the method of any of aspects 1-10, further comprising: compress a payload of the L1 measurement report including at least one of: encoding a first component of the L1 measurement report using a first encoder and encoding a second component of the L1 measurement report using a second encoder, performing a variable length compression of the payload of the L1 measurement report and reporting a variable payload size using a fixed number of bits, or encoding the payload of the L1 measurement report based on an indication from a network entity of at least one of a decoder or an encoder.

Aspect 12 is the method of any of aspects 1-11, where the first encoder compresses the one or more measurements in the L1 measurement report, and the second encoder compresses at least one of a CMR ID or a receive beam ID.

Aspect 13 is the method of any of aspects 1-11, where a first portion of an L1 measurement payload is reported in a first channel state information (CSI) part, and a second portion of the L1 measurement payload is reported in a second CSI part.

Aspect 14 is the method of any of aspects 1-11 and 13, where the first CSI part includes a strongest L1 measurement for the CMR based on a first receive beam, and the second CSI part includes at least one additional L1 measurement for the CMR based on at least one additional receive beam.

Aspect 15 is the method of any of aspects 1-11, 13, and 14, where the first CSI part indicates a payload size of the second portion of the L1 measurement payload in the second CSI part.

Aspect 16 is the method of any of aspects 1-11, where a first measurement for the CMR and a first receive beam is reported in a first channel state information (CSI) report, and at least one additional L1 measurement for the CMR based on at least one additional receive beam is reported in a second CSI report.

Aspect 17 is the method of any of aspects 1-11 and 15, where the first CSI report has a different periodicity than the second CSI report.

Aspect 18 is the method of any of aspects 1-17, further comprising: receiving a configuration of a set of transmission configuration indication (TCI) states having a quasi co-location (QCL) relationship to at least one receive beam at the UE; receiving an activation of at least one TCI state from the set of TCI states; and communicating with a network entity using at least one receive beam having the QCL relationship to the at least one TCI state activated for the UE.

Aspect 19 is the method of any of aspects 1-18, further comprising: applying a switching timeline based on the at least one TCI state meeting a first set of conditions for a known state or a second set of conditions for a partially known state.

Aspect 20 is the method of any of aspects 1-19, where the first set of conditions for the known state includes: a TCI state switch command is received within a time period after a last reference signal for beam reporting or measurement; at least one Layer 1 reference signal received power report is transmitted for the TCI state before receiving the TCI state switch command; the TCI state remains detectable during a TCI state switching period; and a synchronization signal block associated with the TCI state remains detectable during the TCI state switching period.

Aspect 21 is the method of any of aspects 1-20, where the second set of conditions for the partially known state is based on the first set of conditions except for at least one of: the UE does not perform measurements of synchronization signal blocks (SSBs) or channel state information reference signals (CSI-RSs) after a slot in which a TCI state activation is received and before receiving downlink control information (DCI) identifying the TCI state, the UE performs the measurement of the SSBs and does not measure the CSI-RSs after the slot in which the TCI state activation is received and before receiving the DCI identifying the TCI state, or using a timeline parameter for an unknown TCI state with a reduced receive beam sweeping factor for at least one of the SSBs or the CSI-RSs.

Aspect 22 is a method of wireless communication at a network node, comprising: obtaining a layer 1 (L1) measurement report including one or more measurements for a channel measurement resource (CMR) and a reception beam identifier (ID) for a reception beam for each of the one or more measurements at a user equipment (UE), where different measurements associated with a same CMR are associated with different UE identified reception beams; and activating at least one transmission configuration indication (TCI) state having a quasi co-location (QCL) relationship to the reception beam at the UE.

Aspect 23 is the method of aspect 22, further comprising: configuring a set of TCI states having a QCL relationship to at least one receive beam at the UE, where the at least one TCI state is activated from the set of TCI states configured for the UE.

Aspect 24 is the method of aspect 22 or 23 further including that the CMR comprises at least one of a channel state information reference signal (CSI-RS) resources or a synchronization signal block (SSB) resources, and each of the one or more measurements includes at least one of an L1-reference signal received power (L1-RSRP) measurement or an L1-signal to interference and noise ratio (L1-SINR) measurement.

Aspect 25 is the method of any of aspects 22-24, further comprising: obtaining, prior to the L1 measurement report, information identifying a first set of reception beams at the UE; and outputting a configuration for the L1 measurement report indicating for the UE to report an L1 measurement for a second set of reception beams, the second set of reception beams including at least a subset of the first set of reception beams at the UE, where the reception beam ID for the reception beam for each of the one or more measurements is based on the second set of reception beams indicated in the configuration.

Aspect 26 is the method of any of aspects 22-25 further comprising that the configuration is for a semi-persistent channel state information (CSI) report and the second set of reception beams is identified in a medium access control-control element (MAC-CE) activating the semi-persistent CSI report.

Aspect 27 is the method of any of aspects 22-25 further comprising that the configuration is for an aperiodic channel state information (CSI) report and the second set of reception beams is identified in the configuration for the aperiodic CSI report.

Aspect 28 is the method of any of aspects 22-27, where the information identifying the first set of reception beams at the UE includes at least one of beam pointing directions or beam width information.

Aspect 29 is the method of any of aspects 22-28, where the L1 measurement report includes: an absolute value of a first measurement for a first transmission and reception beam pair, and a differential value for each of one or more beam pairs, the differential value being relative to the absolute value for the first transmission and reception beam pair.

Aspect 30 is the method of any of aspects 22-28, where the L1 measurement report includes: an absolute value of a first measurement for a first beam pair for a first CMR, a first differential value for a second CMR using a first receive beam, the first differential value being relative to the absolute value for the first CMR, and a second differential value for the second CMR using a second receive beam, the second differential value being relative to the first differential value.

Aspect 31 is the method of any of aspects 22-30, where the L1 measurement report includes a CMR identifier (ID) and a receive beam ID for each of the one or more measurements included in the L1 measurement report.

Aspect 32 is the method of any of aspects 22-31, further comprising outputting a configuration to report different numbers of beam pair measurements for different CMRs.

Aspect 33 is the method of any of aspects 22-32, where a payload of the L1 measurement report is compressed based on at least one of: a first component of the L1 measurement report encoded using a first encoder and a second component of the L1 measurement report encoded using a second encoder, a variable length compression of the payload of the L1 measurement report and a first indication of a variable payload size using a fixed number of bits, or the payload of the L1 measurement report encoded based on a second indication from a network entity of at least one of a decoder or an encoder.

Aspect 34 is the method of any of aspects 22-32, where a first portion of an L1 measurement payload is reported in a first channel state information (CSI) part, and a second portion of the L1 measurement payload is reported in a second CSI part.

Aspect 35 is the method of aspect 34, where the first CSI part includes a strongest L1 measurement for the CMR based on a first receive beam, and the second CSI part includes at least one additional L1 measurement for the CMR based on at least one additional receive beam.

Aspect 36 is the method of aspect 34 or 35, where the first CSI part indicates a payload size of the second portion of the L1 measurement payload in the second CSI part.

Aspect 37 is the method of any of aspects 22-32, where a first measurement for the CMR and a first receive beam is reported in a first channel state information (CSI) report, and at least one additional L1 measurement for the CMR based on at least one additional receive beam is reported in a second CSI report.

Aspect 38 is the method of aspect 37, where the first CSI report has a different periodicity than the second CSI report.

Aspect 39 is an apparatus for wireless communication at a user equipment (UE) comprising a memory and at least one processor coupled to the memory and configured to perform a method in accordance with any of aspects 1-21.

Aspect 40 is an apparatus for wireless communications, including means for performing a method in accordance with any of aspects 1-21.

Aspect 41 is the apparatus of aspect 39 or 40 further including at least one transceiver configured to transmit the L1 measurement report.

Aspect 42 is a non-transitory computer-readable medium including instructions that, when executed by an apparatus, cause the apparatus to perform a method in accordance with any of aspects 1-21.

Aspect 43 is an apparatus for wireless communication at a network node comprising a memory and at least one processor coupled to the memory configured to perform a method in accordance with any of aspects 22-38.

Aspect 44 is an apparatus for wireless communications, including means for performing a method in accordance with any of aspects 22-38.

Aspect 45 is the apparatus of aspect 43 or 44 further including at least one transceiver configured to obtain the L1 measurement report.

Aspect 46 is a non-transitory computer-readable medium including instructions that, when executed by an apparatus, cause the apparatus to perform a method in accordance with any of aspects 22-38.

What is claimed is:

1. An apparatus for wireless communication at a user equipment (UE), comprising:
memory; and
at least one processor coupled to the memory and configured to:
measure a channel measurement resource (CMR) for each of one or more downlink transmission beams; and
transmit a layer 1 (L1) measurement report including one or more measurements for the CMR and a reception beam identifier (ID) for a reception beam for each of the one or more measurements, wherein different measurements associated with a same CMR are associated with different UE identified reception beams.

2. The apparatus of claim 1, wherein the CMR comprises at least one of a channel state information reference signal (CSI-RS) resources or a synchronization signal block (SSB) resources, and each of the one or more measurements includes at least one of an L1-reference signal received power (L1-RSRP) measurement or an L1-signal to interference and noise ratio (L1-SINR) measurement.

3. The apparatus of claim 1, wherein the at least one processor is further configured to:
transmit, prior to the L1 measurement report, information identifying a first set of reception beams at the UE; and
receive a configuration for the L1 measurement report indicating for the UE to report an L1 measurement for a second set of reception beams, the second set of reception beams including at least a subset of the first set of reception beams at the UE, wherein the reception beam ID for the reception beam for each of the one or more measurements is based on the second set of reception beams indicated in the configuration.

4. The apparatus of claim 3, wherein the information identifying the first set of reception beams at the UE includes at least one of beam pointing directions or beam width information.

5. The apparatus of claim 3, wherein the configuration is for a semi-persistent channel state information (CSI) report and the second set of reception beams is identified in a medium access control-control element (MAC-CE) activating the semi-persistent CSI report.

6. The apparatus of claim 3, wherein the configuration is for an aperiodic channel state information (CSI) report and the second set of reception beams is identified in the configuration for the aperiodic CSI report.

7. The apparatus of claim 1, wherein the L1 measurement report includes:
an absolute value of a first measurement for a first transmission and reception beam pair, and
a differential value for each of one or more beam pairs, the differential value being relative to the absolute value for the first transmission and reception beam pair.

8. The apparatus of claim 1, wherein the L1 measurement report includes:
an absolute value of a first measurement for a first beam pair for a first CMR,
a first differential value for a second CMR using a first receive beam, the first differential value being relative to the absolute value for the first CMR, and
a second differential value for the second CMR using a second receive beam, the second differential value being relative to the first differential value.

9. The apparatus of claim 1, wherein the UE reports a CMR ID and a receive beam ID for each of the one or more measurements included in the L1 measurement report.

10. The apparatus of claim 1, wherein the at least one processor is further configured to:
receive a configuration to report different numbers of beam pair measurements for different CMRs.

11. The apparatus of claim 1, wherein the at least one processor is further configured to:
compress a payload of the L1 measurement report including at least one of:
encoding a first component of the L1 measurement report using a first encoder and encoding a second component of the L1 measurement report using a second encoder,
performing a variable length compression of the payload of the L1 measurement report and reporting a variable payload size using a fixed number of bits, or
encoding the payload of the L1 measurement report based on an indication from a network entity of at least one of a decoder or an encoder.

12. The apparatus of claim 11, wherein the first encoder compresses the one or more measurements in the L1 measurement report, and the second encoder compresses at least one of a CMR ID or a receive beam ID.

13. The apparatus of claim 1, wherein a first portion of an L1 measurement payload is reported in a first channel state information (CSI) part, and a second portion of the L1 measurement payload is reported in a second CSI part.

14. The apparatus of claim 13, wherein the first CSI part includes a strongest L1 measurement for the CMR based on a first receive beam, and the second CSI part includes at least one additional L1 measurement for the CMR based on at least one additional receive beam.

15. The apparatus of claim 13, wherein the first CSI part indicates a payload size of the second portion of the L1 measurement payload in the second CSI part.

16. The apparatus of claim 1, wherein a first measurement for the CMR and a first receive beam is reported in a first channel state information (CSI) report, and at least one additional L1 measurement for the CMR based on at least one additional receive beam is reported in a second CSI report.

17. The apparatus of claim 16, wherein the first CSI report has a different periodicity than the second CSI report.

18. The apparatus of claim 1, wherein the at least one processor is further configured to:
receive a configuration of a set of transmission configuration indication (TCI) states having a quasi co-location (QCL) relationship to at least one receive beam at the UE;
receive an activation of at least one TCI state from the set of TCI states; and
communicate with a network entity using at least one receive beam having the QCL relationship to the at least one TCI state activated for the UE.

19. The apparatus of claim 18, wherein the at least one processor is further configured to:
apply a switching timeline based on the at least one TCI state meeting a first set of conditions for a known state or a second set of conditions for a partially known state.

20. The apparatus of claim 19, wherein the first set of conditions for the known state includes:
a TCI state switch command is received within a time period after a last reference signal for beam reporting or measurement;
at least one Layer 1 reference signal received power report is transmitted for the TCI state before receiving the TCI state switch command;
the TCI state remains detectable during a TCI state switching period; and
a synchronization signal block associated with the TCI state remains detectable during the TCI state switching period.

21. The apparatus of claim 20, wherein the second set of conditions for the partially known state is based on the first set of conditions except for at least one of:
the UE does not perform measurements of synchronization signal blocks (SSBs) or channel state information reference signals (CSI-RSs) after a slot in which a TCI state activation is received and before receiving downlink control information (DCI) identifying the TCI state,
the UE performs the measurement of the SSBs and does not measure the CSI-RSs after the slot in which the TCI state activation is received and before receiving the DCI identifying the TCI state, or
using a timeline parameter for an unknown TCI state with a reduced receive beam sweeping factor for at least one of the SSBs or the CSI-RSs.

22. The apparatus of claim 1, further comprising:
at least one transceiver coupled to the at least one processor and configured to transmit the L1 measurement report.

23. A method of wireless communication at a user equipment (UE), comprising:
measuring a channel measurement resource (CMR) for each of one or more downlink transmission beams; and
transmitting a layer 1 (L1) measurement report including one or more measurements for the CMR and a reception beam identifier (ID) for a reception beam for each of the one or more measurements, wherein different measurements associated with a same CMR are associated with different UE identified reception beams.

24. An apparatus for wireless communication at a network node, comprising:
memory; and
at least one processor coupled to the memory and configured to:
obtain a layer 1 (L1) measurement report including one or more measurements for a channel measurement resource (CMR) and a reception beam identifier (ID) for a reception beam for each of the one or more measurements at a user equipment (UE), wherein different measurements associated with a same CMR are associated with different UE identified reception beams; and
activate at least one transmission configuration indication (TCI) state having a quasi co-location (QCL) relationship to the reception beam at the UE.

25. The apparatus of claim 24, wherein the at least one processor is further configured to:
configure a set of TCI states having a QCL relationship to at least one receive beam at the UE, wherein the at least one TCI state is activated from the set of TCI states configured for the UE.

26. The apparatus of claim 24, wherein the at least one processor is further configured to:
obtain, prior to the L1 measurement report, information identifying a first set of reception beams at the UE; and
output a configuration for the L1 measurement report indicating for the UE to report an L1 measurement for a second set of reception beams, the second set of reception beams including at least a subset of the first set of reception beams at the UE, wherein the reception beam ID for the reception beam for each of the one or more measurements is based on the second set of reception beams indicated in the configuration.

27. The apparatus of claim 26, wherein the information identifying the first set of reception beams at the UE includes at least one of beam pointing directions or beam width information.

28. The apparatus of claim 24, wherein the L1 measurement report includes:
an absolute value of a first measurement for a first transmission and reception beam pair, and
a differential value for each of one or more beam pairs, the differential value being relative to the absolute value for the first transmission and reception beam pair.

29. The apparatus of claim 24, wherein a payload of the L1 measurement report is compressed based on at least one of:
a first component of the L1 measurement report encoded using a first encoder and a second component of the L1 measurement report encoded using a second encoder,
a variable length compression of the payload of the L1 measurement report and a first indication of a variable payload size using a fixed number of bits, or
the payload of the L1 measurement report encoded based on a second indication from a network entity of at least one of a decoder or an encoder.

30. A method of wireless communication at a network node, comprising:
obtaining a layer 1 (L1) measurement report including one or more measurements for a channel measurement resource (CMR) and a reception beam identifier (ID) for a reception beam for each of the one or more measurements at a user equipment (UE), wherein different measurements associated with a same CMR are associated with different UE identified reception beams; and
activating at least one transmission configuration indication (TCI) state having a quasi co-location (QCL) relationship to the reception beam at the UE.
